(19) United States
(12) Patent Application Publication
(10) Pub. No.: US 2009/0228591 A1
(43) Pub. Date: Sep. 10, 2009

(54) INFORMATION PROCESSING APPARATUS, INFORMATION PROCESSING APPARATUS CONTROL METHOD, AND COMPUTER PRODUCT

(75) Inventors: Hideki MITSUNOBU, Kawasaki (JP); Takao MOHRI, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/399,216

(22) Filed: Mar. 6, 2009

(30) Foreign Application Priority Data
Mar. 7, 2008 (JP) 2008-058608

(51) Int. Cl. G06F 15/173

(52) U.S. Cl. 709/226

(57) ABSTRACT

An information processing apparatus includes a service-start notifying unit and an existence-confirmation notifying unit. The service-start notifying unit generates, when a new UPnP service starts, a service-start-time broadcast packet and sends it to other information processing apparatuses in a UPnP network. The existence-confirmation notifying unit generates a service-time broadcast packet and sends it to the other information processing apparatuses in the UPnP network.

### BACKGROUND OF THE INVENTION

1. Field of the Invention

The embodiments discussed herein are directed to a technology for providing information processing apparatuses connected through a network with services.

2. Description of the Related Art

In recent years, along with the widespread use of network connection environment in homes and companies, network technologies for providing services via a network attract attention. In such a network technology, information processing apparatuses, for example, personal computers and peripheral apparatuses thereof, audio visual (AV) apparatuses, and home electronics are connected via a network so that services provided by them are comprehensively available.

As an example of the network technologies, Universal Plug and Play (UPnP) is known. UPnP is a standard that uses a protocol called simple service discovery protocol (SSDP) to detect information processing apparatuses connected to a network and UPnP services provided by the information processing apparatuses. Reference may be had to, for example, Published Japanese Translation No. 2005-526450 of the PCT International Publication.

An information processing apparatus supporting the SSDP sends other information processing apparatuses a packet (hereinafter, “broadcast packet”) including an address of the apparatus, information concerning UPnP services that the apparatus can provide, and a validity period while connected to the network. Hereinafter the information processing apparatus that transmits broadcast packets and provides UPnP services is referred to as “service providing apparatus”, and the information processing apparatus that receives the broadcast packets and uses the UPnP services is referred to as “service using apparatus”.

The service providing apparatus repeats processing for issuing a broadcast packet for each of UPnP services before the validity period (e.g., 60 seconds) expires. The service using apparatus updates the validity period of the UPnP service every time it receives the broadcast packet and recognizes that the UPnP service is available while periodically receiving broadcast packets before the validity period expires. On the other hand, when the validity period expires without receipt of no new broadcast packet, the service using apparatus recognizes that the UPnP service is not available.

Some UPnP service includes a plurality of UPnP services. For example, one UPnP service is divided into a plurality of UPnP services with respect to each of the functions. The UPnP service of this type is available only when all the UPnP services included therein are in operation. Hereinafter the UPnP service including a plurality of UPnP services is referred to as “complex UPnP service”, and the UPnP services included in the complex UPnP service are referred to as “sub-UPnP services”.

When providing a complex UPnP service, the service providing apparatus needs to transmit broadcast packets for the sub-UPnP services. In general, because the service providing apparatus transmits the broadcast packets for the sub-UPnP services at different timings, the service using apparatus also receives the broadcast packets at different timings for each of the sub-UPnP services. Therefore, timing for the service using apparatus to update the validity period is also different for each of the sub-UPnP services and the time the validity period expires is different for each of the sub-UPnP services. When the broadcast packet is not transmitted from the service providing apparatus because, for example, the service providing apparatus is disconnected from the network, the service using apparatus recognizes that the UPnP service is not available at timing different for each of the sub-UPnP services.

To provide a complex UPnP service in the conventional UPnP technology, when, for example, a complex UPnP service includes five sub-UPnP services and the service using apparatus recognizes that three of them are available due to a difference in the time their validity periods expire, the service using apparatus may use the three sub-UPnP services because it does not know that the three sub-UPnP services are part of the complex UPnP service. When using only part of sub-UPnP services included in a complex UPnP service, the service using apparatus needs to detect a sub-UPnP service that is not in operation. This increases processing load due to the detection and development cost for incorporating the detection processing in a program.

When the complex UPnP service is used, broadcast packets from the service providing apparatus increases. Therefore, load on the service providing apparatus for broadcast packet notification processing increases, load on the service using apparatus for broadcast packet reception processing increases, and traffic through the network increases.

Therefore, to provide a complex UPnP service, there is a need for a technology of setting the validity periods for sub-UPnP services included in the complex UPnP service to expire at the same time and thereby reducing necessary broadcast packets.

### SUMMARY

It is an object of the present invention to at least partially solve the problems in the conventional technology.

According to an aspect of the present invention, there is provided an information processing apparatus that provides other information processing apparatus connected via a network with a plurality of services. The information processing apparatus includes: a storage unit that stores service identification numbers for identifying the services and operation state indicating whether the services are in operation; a service-start notifying unit that retrieves, when a service starts anew, all services in operation from the storage unit, and notifies the other information processing apparatus of service start information including information indicating that the retrieved services are in operation and a validity period in which the other information processing apparatus recognizes that the services are in operation; and a confirmation notifying unit that retrieves, before the validity period expires, all services in operation from the storage unit, and notifies the other information processing apparatus of service-time regular information including information indicating that the retrieved services are in operation and the validity period.

According to another aspect of the present invention, there is provided an information processing apparatus that provides other information processing apparatus connected via a network with a plurality of services. The information processing apparatus includes: a storage unit that stores service identification numbers for identifying the services, operation state indicating whether the services are in operation, and a relation identification number indicating, for a complex service including a combination of a plurality of services, that the plurality of services are related to one another; and a service-start notifying unit that retrieves, when a new service starts, all services that are related to the new service and are in operation from the storage unit, and notifies the other information processing apparatus of related service information indicating that the retrieved services are related to one another.

According to still another aspect of the present invention, there is provided an information processing apparatus that uses a plurality of services provided by a predetermined information processing apparatus as a service providing apparatus connected via a network. The information processing apparatus includes: a service-start notifying unit that, having received a request for monitoring the service providing apparatus from the service providing apparatus, detects that the service providing apparatus starts a new service, extracts all services in operation in the service providing apparatus, and notifies other information processing apparatus connected via the network than the service providing apparatus of service start information including information indicating that the extracted services are in operation and a validity period in which the other information processing apparatus recognizes that the services are in operation; and a confirmation notifying unit that, having received a request for monitoring the service providing apparatus from the service providing apparatus, extracts all services in operation in the service providing apparatus before the validity period expires, and notifies the other information processing apparatus of service-time regular information including information indicating that the extracted services are in operation and the validity period.

According to still another aspect of the present invention, there is provided a monitoring apparatus that monitors a radio information processing apparatus that provides other information processing apparatus connected via a network with a plurality of services. The monitoring apparatus includes: an acquiring unit that acquires terminal connection information managed by an access point connected via radio to the radio information processing apparatus; and a confirmation notifying unit that notifies, when it is detected based on the terminal connection information acquired by the acquiring unit that the radio information processing apparatus is disconnected from the network, the other information processing apparatus that the radio information processing apparatus is disconnected from the network.

According to still another aspect of the present invention, there is provided an information processing apparatus control method for controlling an information processing apparatus that provides other information processing apparatus connected via a network with a plurality of services. The information processing apparatus control method includes: storing, in the storage unit, service identification numbers for identifying the services and operation state indicating whether the services are in operation; retrieving, when a service starts anew, all services in operation from the storage unit; notifying the other information processing apparatus of service start information including information indicating that the retrieved services are in operation and a validity period in which the other information processing apparatus recognizes that the services are in operation; retrieving, before the validity period expires, all services in operation from the storage unit; and notifying the other information processing apparatus of service-time regular information including information indicating that the retrieved services are in operation and the validity period.

According to still another aspect of the present invention, there is provided an information processing apparatus control method for controlling an information processing apparatus that provides other information processing apparatus connected via a network with a plurality of services. The information processing apparatus control method includes: storing, in the storage unit, service identification numbers for identifying the services, operation state indicating whether the services are in operation, and a relation identification number indicating, for a complex service including a combination of a plurality of services, that the plurality of services are related to one another; retrieving, when a new service starts, all services that are related to the new service and are in operation from the storage unit; and notifying the other information processing apparatus of related service information indicating that the retrieved services are related to one another.

According to still another aspect of the present invention, there is provided a computer-readable recording medium that stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an example of a UPnP network;

FIG. 2 is a sequence chart of a processing flow in a conventional UPnP service provision system in a UPnP network;

FIG. 3 is a sequence chart of a processing flow in a UPnP service provision system in a UPnP network including information processing apparatuses according to a first embodiment of the present invention;

FIG. 4 is a block diagram of the information processing apparatus according to the first embodiment;

FIG. 5 is an example of contents of a provided-service storage area;

FIG. 6 is an example of contents of a received-service storage area;

FIG. 7 is a flowchart of service-start-time broadcast packet transmission processing performed by a service-start notifying unit depicted in FIG. 4;

FIG. 8 is a flowchart of service-time broadcast packet transmission processing performed by an existence-confirmation notifying unit depicted in FIG. 4;

FIG. 9 is a sequence chart of a processing flow in a UPnP service provision system in a UPnP network including information processing apparatuses according to a second embodiment of the present invention;

FIG. 10 is a block diagram of the information processing apparatus according to the second embodiment;

FIG. 11 is an example of contents of a received-service storage area;

FIG. 12 is a flowchart of service-start-time broadcast packet transmission processing performed by a service-start notifying unit depicted in FIG. 10;

FIG. 13 is a flowchart of apparatus-ID notification packet transmission processing performed by an existence-confirmation notifying unit depicted in FIG. 10;

FIG. 14 is a sequence chart of a processing flow in a UPnP service provision system in a UPnP network including information processing apparatuses according to a third embodiment of the present invention;

FIG. 15 is a block diagram of the information processing apparatus according to the third embodiment;

FIG. 16 is an example of contents of a provided-service storage area;

FIG. 17 is an example of contents of a received-service storage area;

FIG. 18 is a flowchart of broadcast packet transmission processing and related-service broadcast packet transmission processing performed by a service-start notifying unit depicted in FIG. 15;

FIG. 19 is a sequence chart of a processing flow in a UPnP service provision system in a UPnP network including information processing apparatuses according to a fourth embodiment of the present invention;

FIG. 20 is a sequence chart of a processing flow in a UPnP service provision system in a UPnP network including information processing apparatuses according to a fifth embodiment of the present invention;

FIG. 21 is a sequence chart of a processing flow in a UPnP service provision system in a UPnP network including information processing apparatuses according to a sixth embodiment of the present invention;

FIG. 22 is a sequence chart of a processing flow in a UPnP service provision system in a UPnP network including information processing apparatuses according to a seventh embodiment of the present invention;

FIG. 23 is a sequence chart of a processing flow in a UPnP service provision system in a UPnP network including information processing apparatuses according to a eighth embodiment of the present invention;

FIG. 24 is a sequence chart of a processing flow in a UPnP service provision system in a UPnP network including information processing apparatuses according to a ninth embodiment of the present invention;

FIG. 25 is a sequence chart of a processing flow in a UPnP service provision system in a UPnP network including information processing apparatuses according to a tenth embodiment of the present invention;

FIG. 26 is a sequence chart of a processing flow in a UPnP service provision system in a UPnP network including information processing apparatuses according to an eleventh embodiment of the present invention;

FIG. 27 is a sequence chart of a processing flow in a UPnP service provision system in a UPnP network including information processing apparatuses according to a twelfth embodiment of the present invention; and

FIG. 28 is a block diagram of a computer that executes an information processing apparatus control program.

### DETAILED DESCRIPTION OF THE PREFERRED EMBODIMENTS

Exemplary embodiments of the present invention are explained in detail below with reference to the accompanying drawings.

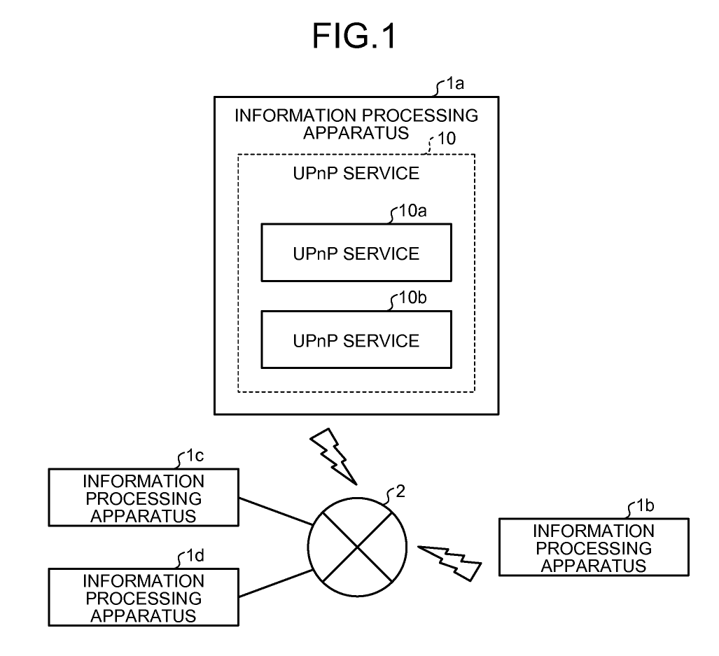

FIG. 1 is a schematic diagram of a network in which UPnP is provided (hereinafter, “UPnP network”). In the UPnP network depicted in FIG. 1, information processing apparatuses 1a to 1d and a network 2 are connected.

The information processing apparatuses 1a to 1d are information processing apparatuses such as a personal computer, a portable terminal, and an AV apparatus. The information processing apparatus 1a provides the information processing apparatuses 1b to 1d with a UPnP service 10. The UPnP service 10 is a complex UPnP service and includes UPnP services 10a and 10b. The information processing apparatus 1a periodically sends, while the connected to the network 2, the information processing apparatuses 1b to 1d broadcast packets including information concerning the UPnP services 10a and 10b. Specifically, the broadcast packets include validity periods that are terms in which the information processing apparatuses 1b to 1d recognize that the UPnP services 10a and 10b are in operation. The information processing apparatus 1a issues the broadcast packets of the UPnP services 10a and 10b again before the validity period expires.

Every time the broadcast packet including the information concerning the UPnP service 10a is received from the information processing apparatus 1a, the information processing apparatuses 1b to 1d update the validity period of the UPnP service 10a. The information processing apparatuses 1b to 1d recognize that the UPnP service 10a is available while the broadcast packet of the UPnP service 10a is continuously received before the validity period expires. Similarly, every time the broadcast packet of the UPnP service 10b is received, the information processing apparatuses 1b to 1d update the validity period of the UPnP service 10b and recognize that the UPnP service 10b is available while the broadcast packet of the UPnP service 10b is continuously received before the validity period expires.

The UPnP network depicted in FIG. 1 is a general example. The conventional information processing apparatus operates in the same environment as that of the information processing apparatus according to the first embodiment.

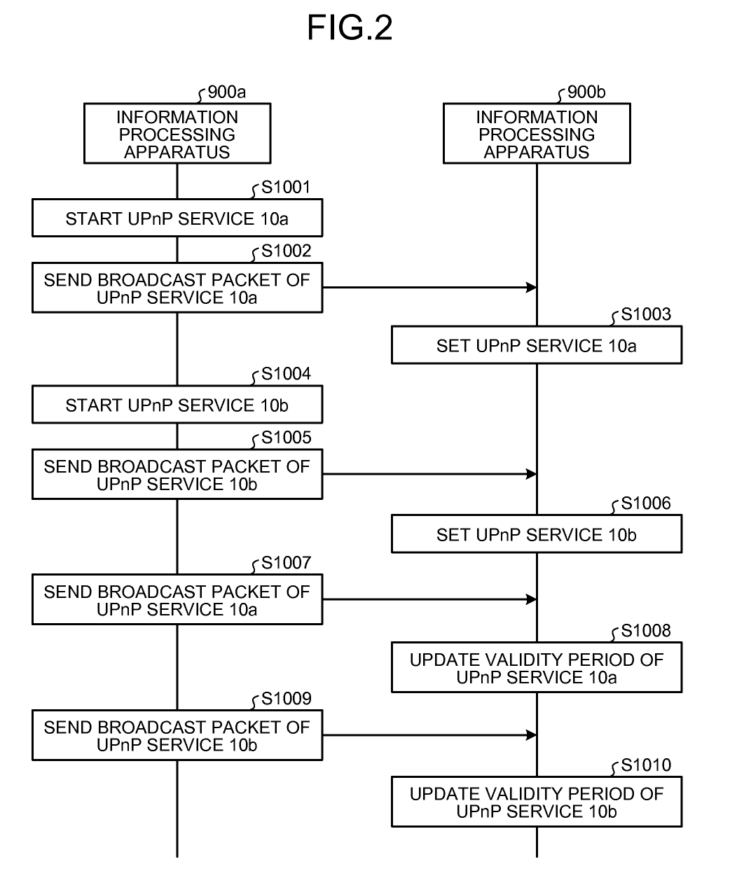

FIG. 2 is a sequence chart of a processing flow in a conventional UPnP service provision system in the UPnP network. Conventional information processing apparatuses 900a to 900d depicted in FIG. 2 correspond to the information processing apparatuses 1a to 1d depicted in FIG. 1. In FIG. 2, for simplification of explanation, a flow of processing by the information processing apparatus 900a and the information processing apparatus 900b is explained. However, other information processing apparatuses (not shown) perform the same processing as that performed by the information processing apparatus 900b.

As illustrated in FIG. 2, the conventional information processing apparatus 900a starts the UPnP service 10a (Step S1001). The information processing apparatus 900a sends the information processing apparatus 900b a broadcast packet including information concerning the UPnP service 10a (Step S1002).

The information processing apparatus 900b receives the broadcast packet of the UPnP service 10a and performs predetermined setting work for using the UPnP service 10a (Step S1003). In the setting work, the information processing apparatus 900b recognizes that the UPnP service 10a is available. The information processing apparatus 900b stores a validity period included in the received broadcast packet in a predetermined storage unit. After the validity period expires, the information processing apparatus 900b recognizes that the UPnP service 10a is not available.

Subsequently, the information processing apparatus 900b starts the UPnP service 10b (Step S1004). The information processing apparatus 900a sends the information processing apparatus 900b a broadcast packet including information concerning the UPnP service 10b (Step S1005). The information processing apparatus 900b receives the broadcast packet of the UPnP service 10b and performs predetermined setting work for using the UPnP service 10b (Step S1006). The information processing apparatus 900b recognizes that the UPnP service 10b is available until a validity period included in the received broadcast packet expires.

Thereafter, the information processing apparatus 900a sends the broadcast packet of the UPnP service 10a to the information processing apparatus 900b before the validity period included in the last broadcast packet expires (Step S1007). The information processing apparatus 900a performs this broadcast packet notification processing while connected to the network 2. Every time a broadcast packet is received, the information processing apparatus 900b updates the validity period of the UPnP service 10a (Step S1008).

Similarly, the information processing apparatus 900a sends a broadcast packet of the UPnP service 10b to the information processing apparatus 900b before the validity period included in the last broadcast packet expires (Step S1009). The information processing apparatus 900b receives the broadcast packet and updates the validity period of the UPnP service 10b (Step S1010).

In this way, while the information processing apparatus 900a is connected to the network 2, the information processing apparatus 900b recognizes that the UPnP services 10a and 10b are available and uses the UPnP service 10.

However, in the conventional UPnP service provision system in the UPnP network, when a service providing apparatus provides the complex UPnP service, the timing of expiration of a validity period is different for each of sub-UPnP services. Therefore, it is likely that a service using apparatus uses only a part of sub-UPnP services included in the complex UPnP service. The load of processing for detecting that sub-UPnP services not started yet are present increases and development cost for incorporating the detection processing in a program increases.

When the complex UPnP service is used, the number of broadcast packets from the service providing apparatus increases. Therefore, the load of broadcast packet notification processing by the service providing apparatus increases, the load of broadcast packet reception processing by the service using apparatus increases, and traffic on the network increases.

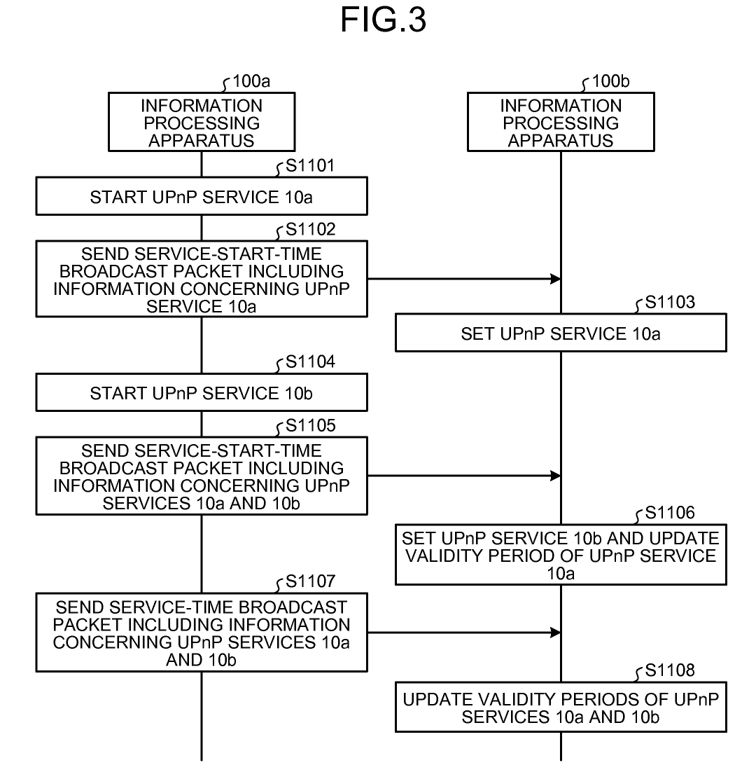

FIG. 3 is a sequence chart of a processing flow in a UPnP service provision system in the UPnP network including information processing apparatuses according to the first embodiment. Information processing apparatuses 100a to 100d of FIG. 3 correspond to the information processing apparatuses 1a to 1d of FIG. 1. In FIG. 3, for simplification of explanation, a flow of processing by the information processing apparatus 100a and the information processing apparatus 100b is explained. However, the information processing apparatus 100a applies the same processing as that applied to the information processing apparatus 100b to other information processing apparatuses (not shown). The other information processing apparatuses perform the same processing as that of the information processing apparatus 100b.

As illustrated in FIG. 3, the information processing apparatus 100a starts the UPnP service 10a (Step S1101). The information processing apparatus 100a generates a packet including information concerning all UPnP services in operation in the apparatus and only one validity period common to all the UPnP services (hereinafter, “service-start-time broadcast packet”) and sends the generated service-start-time broadcast packet to the information processing apparatus 100b (Step S1102). Assuming that only the UPnP service 10a is in operation in the information processing apparatus 100a, the information processing apparatus 100a sends the information processing apparatus 100b a service-start-time broadcast packet including information concerning the UPnP service 10a and a validity period. The service-start-time broadcast packet is a packet in which information concerning a plurality of UPnP services can be set in a broadcast packet (NOTIFY) in the SSDP.

The information processing apparatus 100b receives the service-start-time broadcast packet of the UPnP service 10a and performs predetermined setting work for using the UPnP service 10a (Step S1103). The information processing apparatus 100b stores the validity period included in the received service-start-time broadcast packet in a predetermined storage unit.

Subsequently, the information processing apparatus 100a starts the UPnP service 10b (Step S1104). The information processing apparatus 100a sends the information processing apparatus 100b a service-start-time broadcast packet including information concerning the UPnP services 10a and 10b and a validity period (Step S1105). It is assumed that the UPnP services 10a and 10b are in operation.

The information processing apparatus 100b receives the service-start-time broadcast packet including the information concerning the UPnP services 10a and 10b. The information processing apparatus 100b performs predetermined setting work for using the UPnP service 10b and updates the validity period of the UPnP service 10a stored in the predetermined storage unit to the validity period included in the service-start-time broadcast packet (Step S1106). In this way, the information processing apparatus 100b simultaneously updates the validity periods of the UPnP services 10a and 10b. Therefore, the validity periods of the UPnP services 10a and 10b expire at the same timing.

Thereafter, when predetermined notification timing comes, the information processing apparatus 100a generates a packet including information concerning all UPnP services in operation in the apparatus and a validity period common to all the UPnP services (hereinafter, “service-time broadcast packet”) and sends the generated service-time broadcast packet to the information processing apparatus 100b (Step S1107). Assuming that the UPnP services 10a and 10b are in operation in the information processing apparatus 100a, the information processing apparatus 100a sends the information processing apparatus 100b a service-time broadcast packet including information concerning the UPnP services 10a and 10b and a validity period. While connected to the network 2, the information processing apparatus 100a continues the notification process using the service-time broadcast packet when the predetermined notification timing comes.

The service-time broadcast packet has the same structure as previously described for the service-start-time broadcast packet. The “predetermined notification timing” indicates timing at least before a validity period included in the last service-start-time broadcast packet or the last service-time broadcast packet expires. For example, in the case of a service-time broadcast packet in which “600 seconds” is set as a validity period, the information processing apparatus 100a issues the service-time broadcast packet before “600 seconds” elapses.

The information processing apparatus 100b that receives the service-time broadcast packet updates the validity periods of the UPnP services 10a and 10b stored in the predetermined storage unit to the validity period included in the service-time broadcast packet (Step S1108).

In this way, each of the information processing apparatuses 100a to 100d according to the first embodiment sends the other information processing apparatuses a service-start-time broadcast packet or a service-time broadcast packet including information concerning all UPnP services in operation in the apparatus. Therefore, even when a complex UPnP service is provided, broadcast packets issued for each of sub-UPnP services in the conventional technology can be reduced to one packet (the service-start-time broadcast packet or the service-time broadcast packet). As a result, it is possible to reduce load on the service providing apparatus (in the example of FIG. 3, the information processing apparatus 100a) for broadcast packet notification processing, load on the service using apparatus (in the example of FIG. 3, the information processing apparatuses 100b to 100d) for broadcast packet reception processing, and traffic on the network.

A broadcast packet in the SSDP is described in the Extensible Markup Language (XML). Therefore, an information amount of header information fixedly set in the broadcast packet is large. However, a service-start-time broadcast packet or a service-time broadcast packet in which information concerning a plurality of UPnP services can be set has one piece of header information. Therefore, it is possible to reduce traffic on the network.

Because load on the broadcast packet notification processing and load on the broadcast packet reception processing can be reduced, for example, when an information processing apparatus is a portable terminal, it is possible to extend the life of a power supply battery of the portable terminal.

The information processing apparatuses 100a to 100d according to the first embodiment simultaneously updates validity periods of all UPnP services. Therefore, timing of expiration of a validity period is not different for each of sub-UPnP services. This makes it possible to prevent only part of sub-UPnP services included in a complex UPnP service from being used.

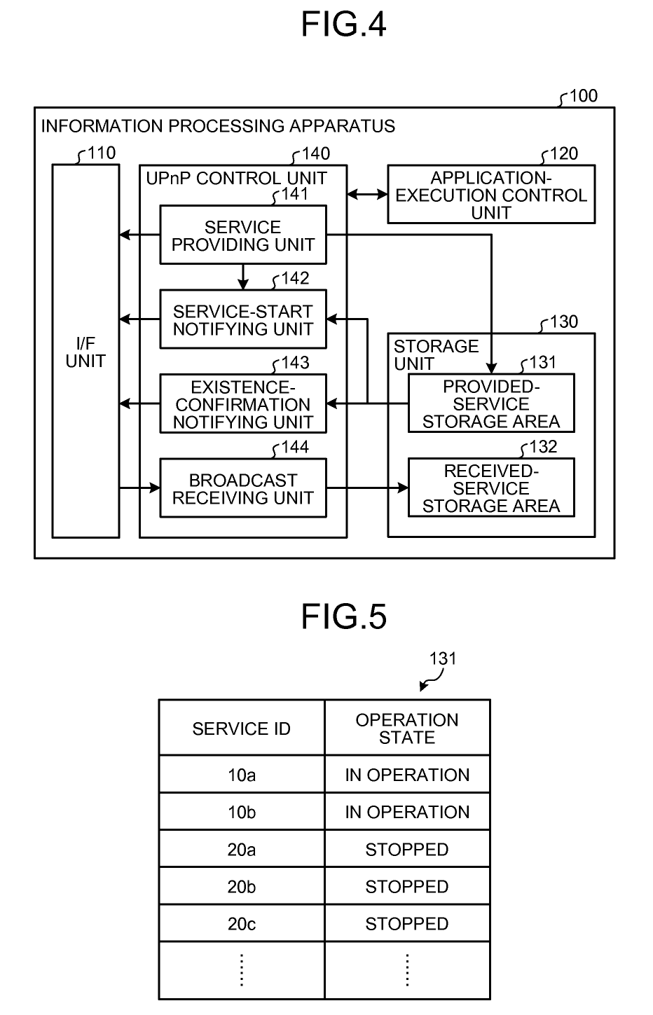

FIG. 4 is a block diagram of an information processing apparatus 100 according to the first embodiment. The information processing apparatus 100 of FIG. 4 corresponds to the information processing apparatuses 100a to 100d explained above. FIG. 4 depicts only components related to the UPnP.

As illustrated in FIG. 4, the information processing apparatus 100 includes an interface (I/F) unit 110, an application-execution control unit 120, a storage unit 130, and a UPnP control unit 140.

The I/F unit 110 is an interface for transmitting and receiving information via a network. The application-execution control unit 120 controls execution of various applications. The application-execution control unit 120 instructs, when necessary, the UPnP control unit 140 to perform, for example, provision of a UPnP service or notification processing by a service-start-time broadcast packet or a service-time broadcast packet.

The storage unit 130 stores various kinds of information. The storage unit 130 includes a provided-service storage area 131 and a received-service storage area 132. The provided-service storage area 131 stores information indicating whether UPnP services that can be provided by the information processing apparatus 100 are in operation.

FIG. 5 illustrates an example of contents of the provided-service storage area 131. As illustrated in FIG. 5, the contents of the provided-service storage area 131 includes items such as service ID and operation state. The service ID is an identification number for uniquely identifying a UPnP service. In the example of FIG. 5, signs affixed to the UPnP services 10a and 10b in FIG. 1 are service IDs. The operation state indicates whether a UPnP service corresponding to the service ID is in operation. The first row of the provided-service storage area 131 indicates that the UPnP service 10a is in operation. The second row of the provided-service storage area 131 indicates that the UPnP service 10b is in operation.

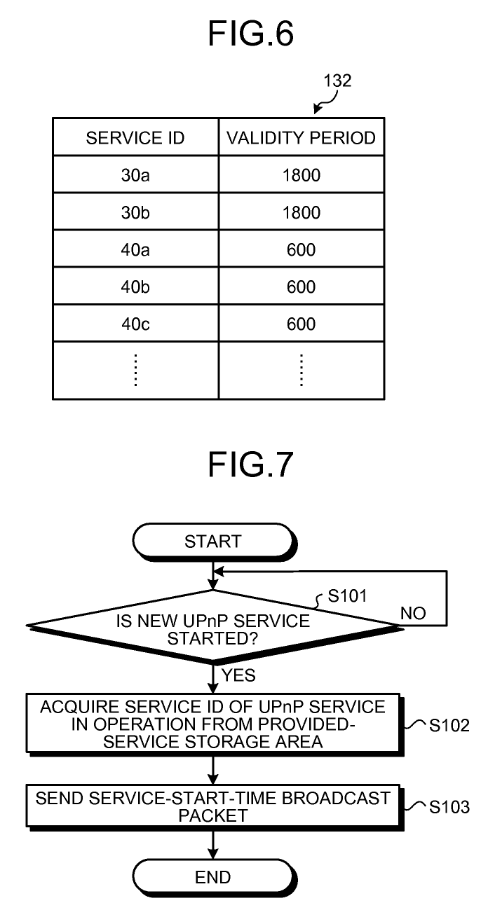

The received-service storage area 132 stores information concerning UPnP services provided by the other information processing apparatuses in the UPnP network. FIG. 6 illustrates an example of contents of the received-service storage area 132. As illustrated in FIG. 6, the contents of the received-service storage area 132 includes items such as service ID and validity period. Like the service ID explained above, the service ID is an identification number for uniquely identifying a UPnP service. The validity period is a period in which the UPnP service is valid.

The UPnP control unit 140 performs various kinds of control related to the UPnP. The UPnP control unit 140 includes a service providing unit 141, a service-start notifying unit 142, an existence-confirmation notifying unit 143, and a broadcast receiving unit 144.

The service providing unit 141 performs predetermined information processing in response to a request from a user to thereby start or stop a predetermined UPnP service and control provision of the UPnP service. When the predetermined UPnP service is started, the service providing unit 141 updates operation state in the provided-service storage area 131 corresponding to a service ID of the UPnP service to indicate that the UPnP service is in operation. When the predetermined UPnP service is stopped, the service providing unit 141 updates the operation state in the provided-service storage area 131 corresponding to the service ID of the UPnP service to indicate that the UPnP service is stopped.

The service-start notifying unit 142 generates, when a new UPnP service is started by the service providing unit 141, a service-start-time broadcast packet and sends the other information processing apparatuses in the UPnP network the generated service-start-time broadcast packet.

Specifically, when a new UPnP service is started by the service providing unit 141, the service-start notifying unit 142 acquires, from the provided-service storage area 131, all service IDs each corresponding to operation state indicating that a UPnP service is in operation. The service-start notifying unit 142 generates a service-start-time broadcast packet including information concerning all the UPnP services (service IDs, service names, etc.) indicated by the acquired service IDs and a validity period common to all the UPnP services. The service-start notifying unit 142 sends the other information processing apparatuses in the UPnP network the generated service-start-time broadcast packet via the I/F unit 110.

The existence-confirmation notifying unit 143 generates, when predetermined notification timing comes, a service-time broadcast packet and sends the other information processing apparatuses in the UPnP network the generated service-time broadcast packet.

Specifically, at least before a validity period included in the last service-start-time broadcast packet or the last service-time broadcast packet expires, the existence-confirmation notifying unit 143 acquires, from the provided-service storage area 131, all service IDs each corresponding to operation state indicating that a UPnP service is in operation. The existence-confirmation notifying unit 143 generates a service-time broadcast packet including information concerning all the UPnP services (service IDs, service names, etc.) indicated by the acquired service IDs and a validity period common to all the UPnP services. The existence-confirmation notifying unit 143 sends the other information processing apparatuses in the UPnP network the generated service-time broadcast packet. The existence-confirmation notifying unit 143 continues the notification process using the service-time broadcast packet while the information processing apparatus 100 is connected to the network 2.

The broadcast receiving unit 144 receives a service-start-time broadcast packet or a service-time broadcast packet from another information processing apparatus in the UPnP network and performs predetermined setting work for using a UPnP service based on various kinds of information included in the service-start-time broadcast packet or the service-time broadcast packet.

Specifically, when a service-start-time broadcast packet is received, the broadcast receiving unit 144 performs predetermined setting work for using a UPnP service included in the service-start-time broadcast packet. When a service-time broadcast packet is received, the broadcast receiving unit 144 extracts a service ID and a validity period from the service-time broadcast packet and updates a validity period in the received-service storage area 132 corresponding to the extracted service ID to the extracted validity period.

FIG. 7 is a flowchart of service-start-time broadcast packet transmission processing performed by the service-start notifying unit 142.

As illustrated in FIG. 7, when a new UPnP service is started by the service providing unit 141 (Yes at Step S101), the service-start notifying unit 142 acquires, from the provided-service storage area 131, all service IDs each corresponding to operation state indicating that a UPnP service is in operation (Step S102).

The service-start notifying unit 142 generates a service-start-time broadcast packet including information concerning all UPnP services indicated by the service ID acquired from the provided-service storage area 131 and a validity period common to all the UPnP services, and sends the other information processing apparatuses in the UPnP network the service-start-time broadcast packet (Step S103).

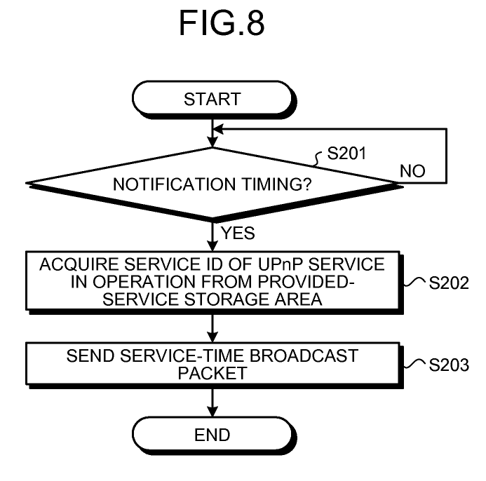

FIG. 8 is a flowchart of service-time broadcast packet transmission processing performed by the existence-confirmation notifying unit 143.

As illustrated in FIG. 8, when predetermined notification time comes (Yes at Step S201), the existence-confirmation notifying unit 143 acquires, from the provided-service storage area 131, all service IDs each corresponding to operation state indicating that a UPnP service is in operation (Step S202).

The existence-confirmation notifying unit 143 generates a service-time broadcast packet including information concerning all UPnP services indicated by the service IDs acquired from the provided-service storage area 131 and a validity period common to all UPnP services, and sends the other information processing apparatuses in the UPnP network the service-time broadcast packet (Step S203).

As explained above, in the information processing apparatus 100 according to the first embodiment, when a new UPnP service is started, the service-start notifying unit 142 generates a service-start-time broadcast packet and transmits the service-start-time broadcast packet to the other information processing apparatuses in the UPnP network. When the predetermined notification timing comes, the existence-confirmation notifying unit 143 generates a service-time broadcast packet and transmits the service-time broadcast packet to the other information processing apparatuses in the UPnP network. Therefore, even when a complex UPnP service is provided, it is possible to set validity periods for sub-UPnP services included in the complex UPnP service to expire at the same timing and to reduce the number of broadcast packets

In the first embodiment, when a new UPnP service is started, an information processing apparatus that provides such a UPnP service unilaterally sends the other information processing apparatuses a service-start-time broadcast packet. However, the service using apparatus can request the service providing apparatus to send the service-start-time broadcast packet thereto. In a second embodiment, when a new UPnP service is started, an information processing apparatus that uses the UPnP service requests an information processing apparatus that provides the UPnP service to send a service-start-time broadcast packet thereto.

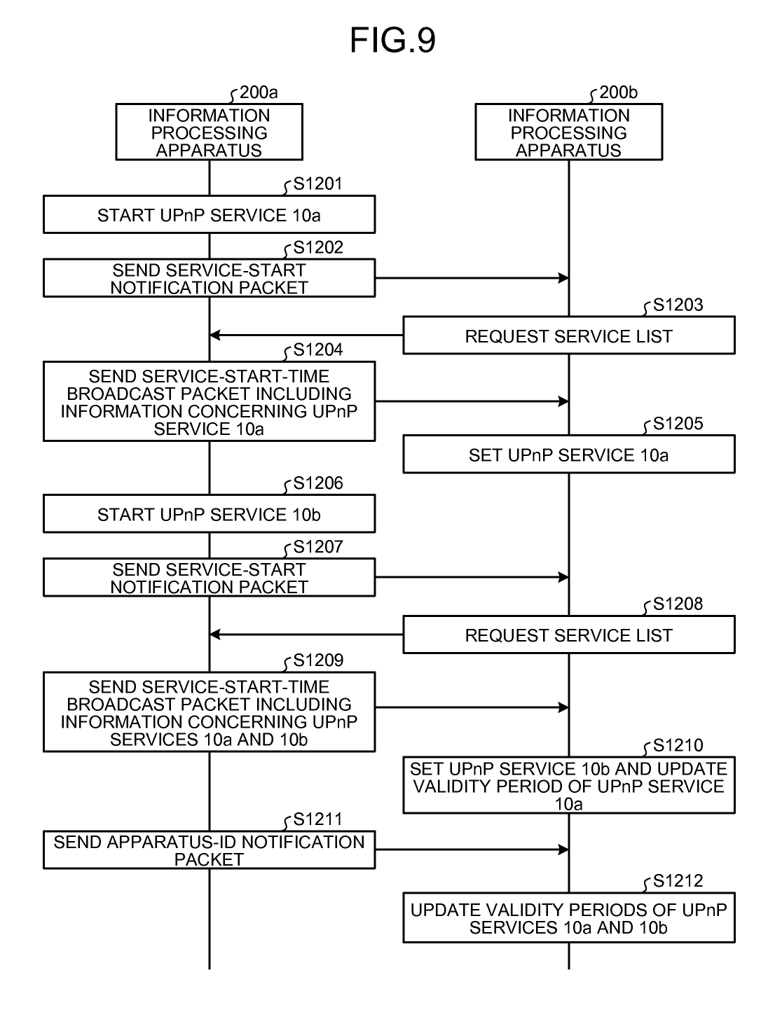

FIG. 9 is a sequence chart of a processing flow in a UPnP service provision system in a UPnP network including information processing apparatuses according to the second embodiment. Information processing apparatuses 200a and 200b according to the second embodiment in FIG. 9 correspond to the information processing apparatuses 1a to 1d in FIG. 1. For simplification of explanation, a flow of processing by the two information processing apparatus 200a and 200b is explained. However, the information processing apparatus 200a can apply the same processing as is applied to the information processing apparatus 200b to other information processing apparatuses (not shown). The other information processing apparatuses perform the same processing as is performed by the information processing apparatus 200b.

As illustrated in FIG. 9, the information processing apparatus 200a starts the UPnP service 10a (Step S1201). The information processing apparatus 200a sends the information processing apparatus 200b a packet including an apparatus ID for uniquely identifying an information processing apparatus in the UPnP network (hereinafter, “service-start notification packet”) (Step S1202).

The service-start notification packet is a packet for an information processing apparatus that provides a UPnP service to notify the other information processing apparatuses that a new UPnP service is started. Information set in the apparatus ID included in the service-start notification packet only has to be a value with which an information processing apparatus can be uniquely identified in the UPnP network. Examples of the information include a media access control (MAC) address of the information processing apparatus, and a serial number of the information processing apparatus.

The information processing apparatus 200b receives the service-start notification packet and requests the information processing apparatus 200a to send thereto a list of UPnP services in operation (hereinafter, “service list request”) (Step S1203). The information processing apparatus 200a receives the service list request and sends the information processing apparatus 200b a service-start-time broadcast packet including information concerning the UPnP service 10a and a validity period (Step S1204). It is assumed that the UPnP service 10a is in operation.

The information processing apparatus 200b receives the service-start-time broadcast packet of the UPnP service 10a and performs predetermined setting work for using the UPnP service 10a (Step S1205). The information processing apparatus 200b stores the service ID and the validity period of the UPnP service 10a in a predetermined storage unit in association with the apparatus ID included in the received service-start notification packet.

Subsequently, the information processing apparatus 200a starts the UPnP service 10b (Step S1206). The information processing apparatus 200a sends the service-start notification packet to the information processing apparatus 200b (Step S1207).

The information processing apparatus 200b receives the service-start notification packet and sends a service list request to the information processing apparatus 200a (Step S1208). The information processing apparatus 200a receives the service list request and sends the information processing apparatus 200b a service-start-time broadcast packet including information concerning the UPnP services 10a and 10b and a validity period (Step S1209). It is assumed that the UPnP services 10a and 10b are in operation.

The information processing apparatus 200b receives the service-start-time broadcast packet of the UPnP services 10a and 10b, performs predetermined setting work for using the UPnP service 10b, and updates the validity period of the UPnP service 10a to the validity period included in the service-start-time broadcast packet (Step S1210). The information processing apparatus 200b stores the service ID and the validity period of the UPnP service 10b in a predetermined storage unit in association with the apparatus ID included in the received service-start notification packet. In other words, the information processing apparatus 200b stores the service IDs and the validity periods of the UPnP services 10a and 10b in the predetermined storage unit in association with the apparatus ID of the information processing apparatus 200a.

Thereafter, when predetermined notification timing comes, the information processing apparatus 200a generates a packet including the apparatus ID and the validity period (hereinafter, “apparatus-ID notification packet”) and sends the generated apparatus-ID notification packet to the information processing apparatus 200b (Step S1211).

The “predetermined notification timing” indicates timing at least before a validity period included in the last service-start-time broadcast packet or the last service-time broadcast packet expires.

The information processing apparatus 200b receives the apparatus-ID notification packet from the information processing apparatus 200a and updates the validity period stored in the predetermined storage unit in association with the apparatus ID of the information processing apparatus 200a to the validity period included in the apparatus-ID notification packet (Step S1212).

FIG. 10 is a block diagram of an information processing apparatus 200 according to the second embodiment. The information processing apparatus 200 in FIG. 10 corresponds to the information processing apparatuses 200a and 200b explained above. FIG. 10 depicts only components related to the UPnP. In FIG. 10, like reference numerals refer to corresponding components having the same functions as those of the components depicted in FIG. 4, and the detailed explanation thereof is omitted.

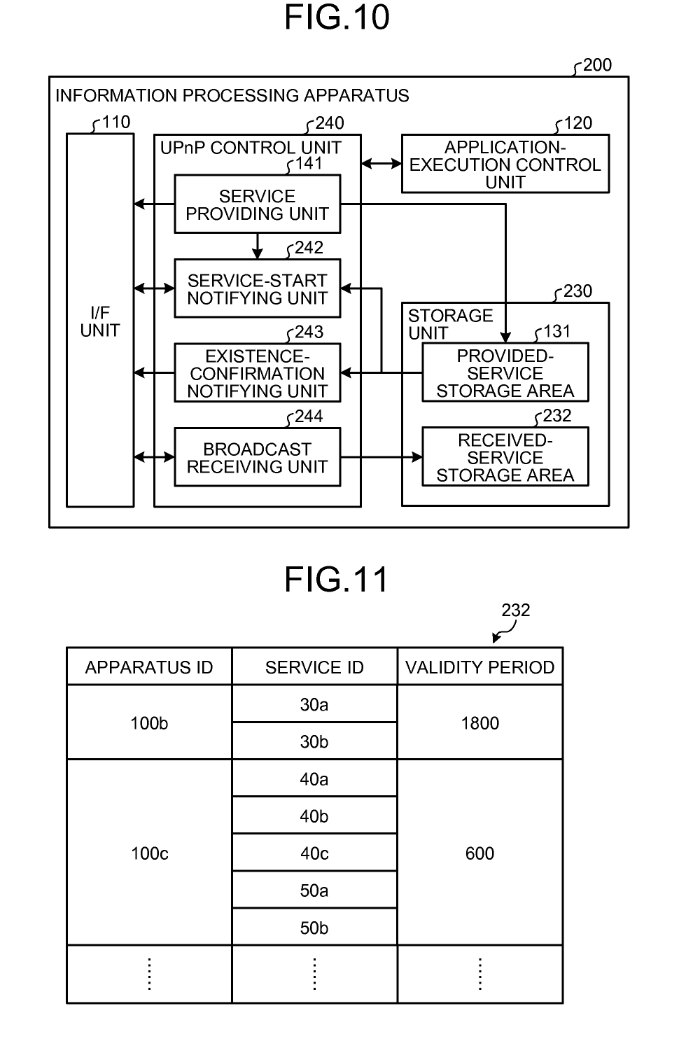

A received-service storage area 232 of a storage unit 230 stores, in information processing apparatus units, UPnP services provided by the other information processing apparatuses in the UPnP network. FIG. 11 illustrates an example of contents of the received-service storage area 232. As illustrated in FIG. 11, the contents of the received-service storage area 232 includes items such as apparatus ID, service ID, and validity period. The received-service storage area 232 is updated by a broadcast receiving unit 244 explained later. Update processing for the received-service storage area 232 by the broadcast receiving unit 244 is explained later.

When a new UPnP service is started by the service providing unit 141, a service-start notifying unit 242 of a UPnP control unit 240 generates a service-start notification packet including an apparatus ID of the information processing apparatus 200 and sends the service-start notification packet to the other information processing apparatuses. When a service list request is received from another information processing apparatus that receives the service-start notification packet, the service-start notifying unit 242 generates a service-start-time broadcast packet and sends the generated service-start-time broadcast packet to only the information processing apparatus, which has sent the service list request.

An existence-confirmation notifying unit 243 of the UPnP control unit 240 generates an apparatus-ID notification packet and sends the apparatus-ID notification packet to the other information processing apparatuses in the UPnP network when predetermined notification timing comes.

Specifically, at least before a validity period included in the last service-start-time broadcast packet or the last apparatus-ID notification packet expires, the existence-confirmation notifying unit 243 acquires, from the provided-service storage area 131, the number of records each corresponding to operation state indicating that a UPnP service is in operation. When the acquired number of records is equal to or larger than “1”, the existence-confirmation notifying unit 243 generates an apparatus-ID notification packet including an apparatus ID and a validity period, and sends the generated apparatus-ID notification packet to the other information processing apparatuses in the UPnP network.

The broadcast receiving unit 244 of the UPnP control unit 240 receives a service-start notification packet, a service-start-time broadcast packet, or an apparatus-ID notification packet from the other information processing apparatuses in the UPnP network and performs predetermined setting work for using a UPnP service.

Specifically, upon receipt of a service-start notification packet, the broadcast receiving unit 244 causes the received-service storage area 232 to store an apparatus ID included in the service-start notification packet. The broadcast receiving unit 244 sends a service list request to an information processing apparatus at a transmission source of the service-start notification packet (hereinafter, “transmission-source information processing apparatus”). When a service-start-time broadcast packet is received from the transmission-source information processing apparatus in response to the service list request, the broadcast receiving unit 244 performs predetermined setting work for using a UPnP service included in the service-start-time broadcast packet. The broadcast receiving unit 244 stores a service ID included in the service-start-time broadcast packet in the service ID in the received-service storage area 232 corresponding to the apparatus ID stored when the service-start notification packet is received.

Upon receipt of an apparatus-ID notification packet, the broadcast receiving unit 244 updates the validity period in the received-service storage area 232 corresponding to an apparatus ID included in the apparatus-ID notification packet to a validity period included in the apparatus-ID notification packet.

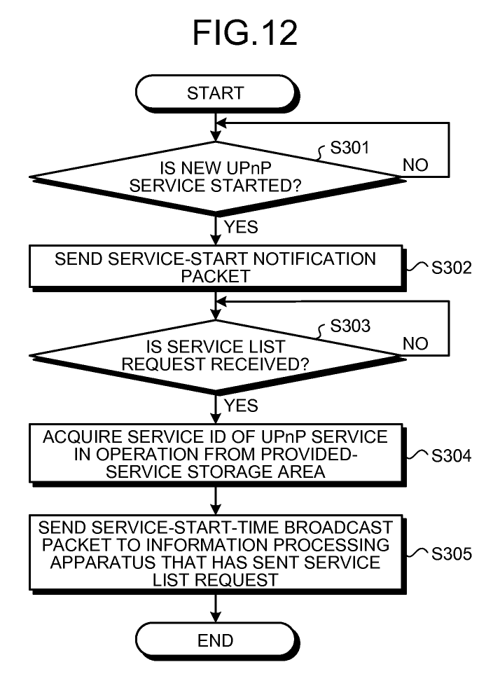

FIG. 12 is a flowchart of service-start-time broadcast packet transmission processing performed by the service-start notifying unit 242.

As illustrated in FIG. 12, when a new UPnP service is started by the service providing unit 141 (Yes at Step S301), the service-start notifying unit 242 sends a service-start notification packet to the other information processing apparatuses (Step S302).

When a service list request is received from another information processing apparatus that receives the transmitted service-start notification packet (Yes at Step S303), the service-start notifying unit 242 acquires, from the provided-service storage area 131, all service IDs each corresponding to operation state indicating that a UPnP service is in operation is stored (Step S304).

The service-start notifying unit 242 sends only the information processing apparatus, which has sent the service list request, a service-start-time broadcast packet including information concerning all UPnP services indicated by the service IDs acquired from the provided-service storage area 131 and a validity period common to all the UPnP services (Step S305).

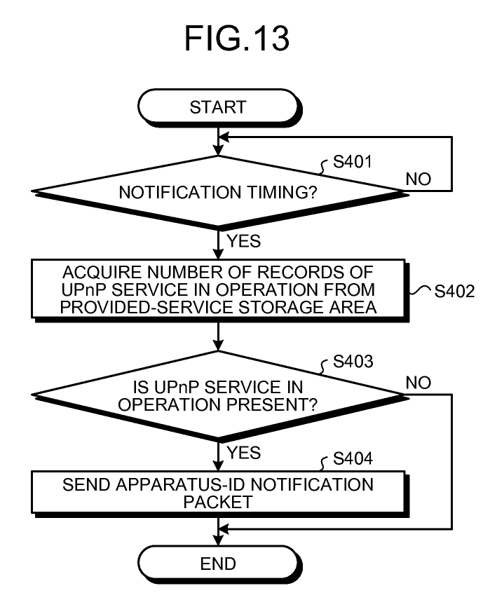

FIG. 13 is a flowchart of apparatus-ID notification packet transmission processing performed by the existence-confirmation notifying unit 243.

As illustrated in FIG. 13, when predetermined notification timing comes (Yes at Step S401), the existence-confirmation notifying unit 243 acquires, from the provided-service storage area 131, the number of records each corresponding to operation state indicating that a UPnP service is in operation (Step S402).

When the number of records acquired from the provided-service storage area 131 is equal to or larger than “1”, i.e., a UPnP service in operation is present in the information processing apparatus 200 (Yes at Step S403), the existence-confirmation notifying unit 243 generates an apparatus-ID notification packet including the apparatus ID of the information processing apparatus 200 and a validity period, and sends the apparatus-ID notification packet to the other information processing apparatuses in the UPnP network (Step S404).

On the other hand, when the number of records acquired from the provided-service storage area 131 is “0”, i.e., a UPnP service in operation is not present in the information processing apparatus 200 (No at Step S403), the existence-confirmation notifying unit 243 ends the processing.

As explained above, in the information processing apparatus 200 according to the second embodiment, when a new UPnP service is started, the service-start notifying unit 242 sends a service-start notification packet to other information processing apparatuses. When a service list request responding to the service-start notification packet is received, the service-start notifying unit 242 sends a service-start-time broadcast packet to the information processing apparatus, which has sent the service list request. When the predetermined notification time comes, the existence-confirmation notifying unit 243 issues an apparatus ID notification packet. Therefore, even when a complex UPnP service is provided, it is possible to set validity periods for sub-UPnP services included in the complex UPnP service to expire at the same timing and to reduce the number of broadcast packets. Moreover, the service using apparatus can control reception timing for the service-start notification packet. Consequently, when the service using apparatus is in a high load state, it is possible to prevent the service providing apparatus from sending the service-start notification packet to the service using apparatus.

In the first and second embodiment, the service using apparatus does not recognize which sub-UPnP services are included in a complex UPnP service. However, the service using apparatus can be configured to recognize which sub-UPnP services are included in a complex UPnP service. In a third embodiment, the service using apparatus recognizes relation among sub-UPnP services included in a complex UPnP service.

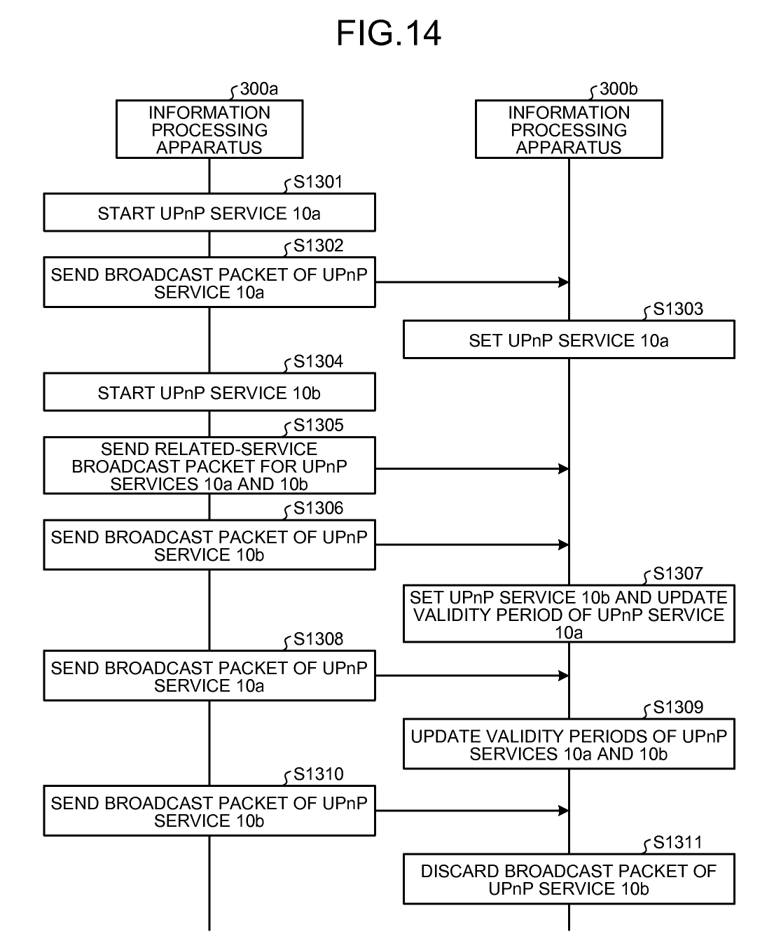

FIG. 14 is a sequence chart of a processing flow in a UPnP service provision system in a UPnP network including information processing apparatuses according to the third embodiment. Information processing apparatuses 300a and 300b according to the third embodiment in FIG. 14 correspond to the information processing apparatuses 1a to 1d in FIG. 1. In Fig. 14, for simplification of explanation, a flow of processing by the two information processing apparatus 300a and the information processing apparatus 300b is explained. However, the information processing apparatus 300a applies the same processing as is applied to the information processing apparatus 300b to other information processing apparatuses (not shown). The other information processing apparatuses performs the same processing as is performed by the information processing apparatus 300b.

As illustrated in FIG. 14, the information processing apparatus 300a starts the UPnP service 10a (Step S1301). In the same manner as the conventional information processing apparatus 900a, the information processing apparatus 300a sends the information processing apparatus 300b a broadcast packet of the UPnP service 10a (Step S1302). The information processing apparatus 300b receives the broadcast packet of the UPnP service 10a and performs predetermined setting work for using the UPnP service 10a (Step S1303).

Subsequently, the information processing apparatus 300a starts the UPnP service 10b (Step S1304). The information processing apparatus 300a sends the information processing apparatus 300b a packet indicating that the UPnP service 10a and the UPnP service 10b are related (hereinafter, “related service broadcast packet”) (Step S1305). “The UPnP service 10a and the UPnP service 10b are related” means that the UPnP service 10a and the UPnP service 10b are elements of an identical complex UPnP service. Having received the related service broadcast packet, the information processing apparatus 300b recognizes that the UPnP service 10a and the UPnP service 10b are related.

Subsequently, the information processing apparatus 300a sends the information processing apparatus 300b a broadcast packet of the UPnP service 10b (Step S1306). Upon receipt of the broadcast packet of the UPnP service 10b, the information processing apparatus 300b performs predetermined setting work for using the UPnP service 10b and updates a validity period of the UPnP service 10a stored in the predetermined storage unit to a validity period included in the broadcast packet (Step S1307). Since the information processing apparatus 300b has been notified that the UPnP service 10a and the UPnP service 10b are related, when receiving the broadcast packet of the UPnP service 10b, it updates the validity period of the UPnP service 10a. This makes it possible to set validity periods for the UPnP services 10a and 10b to expire at the same time.

In the example of FIG. 14, the information processing apparatus 300a issues the broadcast packet of the UPnP service 10b after the related service broadcast packet. However, the information processing apparatus 300a may issue the related service broadcast packet after the broadcast packet of the UPnP service 10b.

Thereafter, the information processing apparatus 300a sends the information processing apparatus 300b a broadcast packet of the UPnP service 10a before a validity period included in the last broadcast packet expires (Step S1308). Upon receipt of the broadcast packet, the information processing apparatus 300b updates validity periods of the UPnP service 10a and the UPnP service 10b related to the UPnP service 10a (Step S1309).

The information processing apparatus 300a sends the broadcast packet of the UPnP service 10b to the information processing apparatus 300b before a validity period included in the last broadcast packet expires (Step S1310). Upon receipt of the broadcast packet of the UPnP service 10b, the information processing apparatus 300b discards the broadcast packet (Step S1311). This is because, when the information processing apparatus 300b receives one of the UPnP services 10a or 10b, the information processing apparatus 300b can update the validity period of the UPnP service 10a or 10b. The information processing apparatus 300b determines in advance which of the broadcast packets of the UPnP services 10a and 10b is discarded. For example, when a service ID is information that can be compared like a numerical value, the information processing apparatus 300b determines in advance that the broadcast packet with a smaller service ID is discarded.

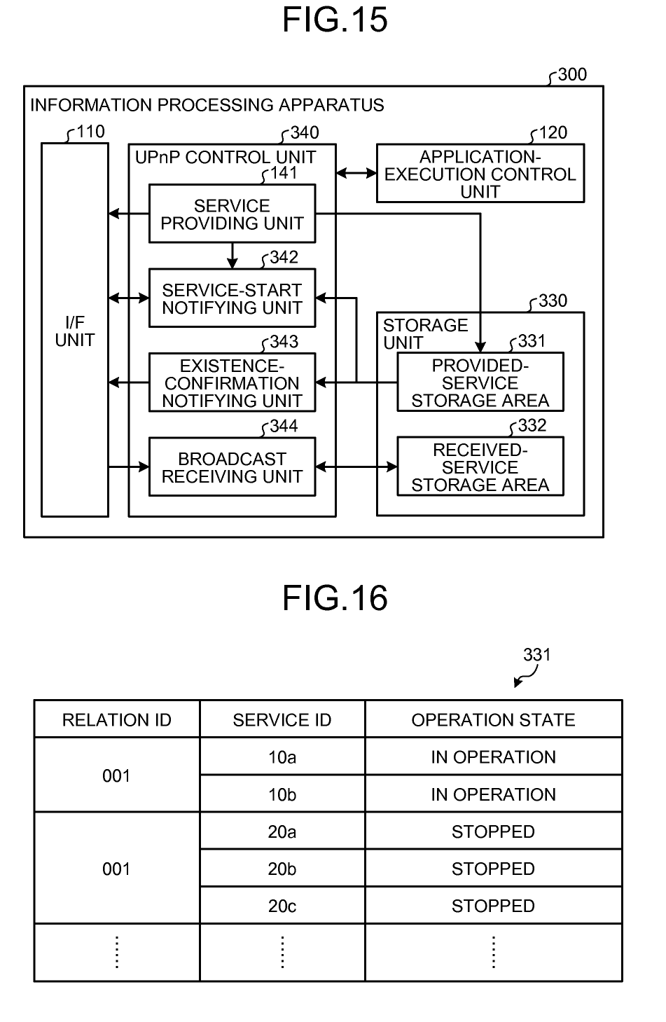

FIG. 15 is a block diagram of an information processing apparatus 300 according to the third embodiment. The information processing apparatus 300 in FIG. 15 corresponds to the information processing apparatuses 300a and 300b explained above. FIG. 15 depicts only components related to the UPnP. Like reference numerals refer to corresponding components having the same functions as those of FIGS. 4 and 10, and detailed explanation thereof is omitted.

A provided-service storage area 331 of a storage unit 330 stores information indicating whether UPnP services that can be provided by the information processing apparatus 300 are in operation and information indicating relation of the UPnP services. FIG. 16 illustrates an example of contents of the provided-service storage area 331. As illustrated in FIG. 16, the contents of the provided-service storage area 331 includes items such as relation ID, service ID, and operation state. The relation ID is an identification number for uniquely identifying relation of the UPnP services. A first row of the provided-service storage area 331 indicates that the UPnP service 10a with the service ID “10a” and a UPnP service 10b with the service ID “10b” are related. A second row of the provided-service storage area 331 indicates that a UPnP service 20a with the service ID “20a”, a UPnP service 20b with the service ID “20b”, and a UPnP service 20c with the service ID “20c” are related.

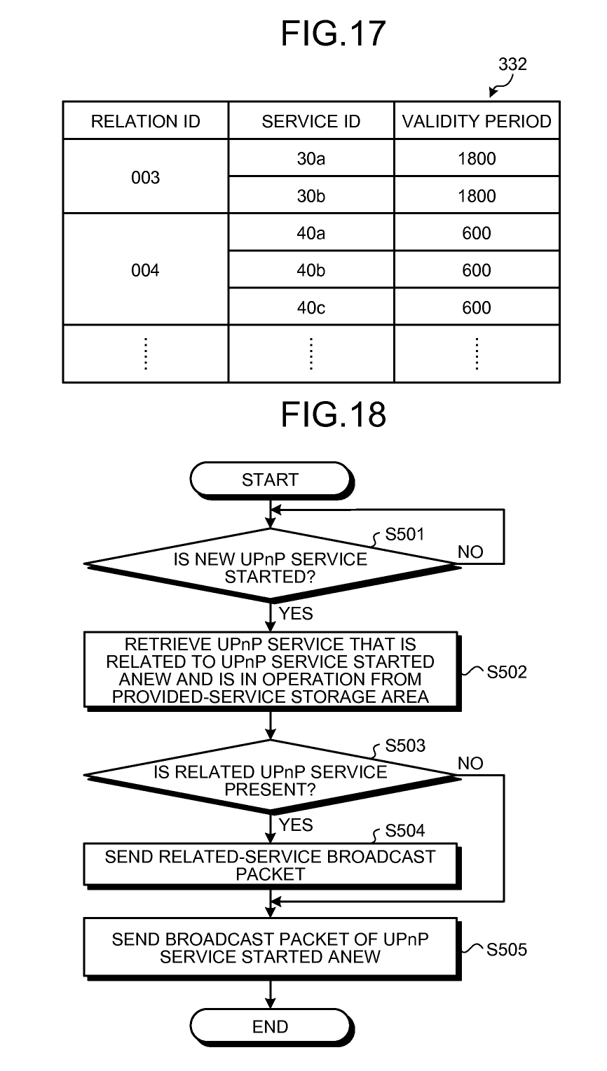

A received-service storage area 332 of the storage unit 330 stores information concerning UPnP services provided by the other information processing apparatuses in the UPnP network. FIG. 17 illustrates an example of contents of the received-service storage area 332. As illustrated in FIG. 17, the contents of the received-service storage area 332 includes items such as relation ID, service ID, and validity period. The relation ID is the same item as the relation ID of the provided-service storage area 331 in FIG. 16.

A service-start notifying unit 342 of a UPnP control unit 340 sends, when a new UPnP service is started by the service providing unit 141, other information processing apparatuses a broadcast packet of the UPnP service and also a related-service broadcast packet.

Specifically, when a new UPnP service is started, the service-start notifying unit 342 retrieves a UPnP service that is related to the UPnP service started anew and is in operation from the provided-service storage area 331. The service-start notifying unit 342 generates a related-service broadcast packet indicating that the retrieved UPnP service and the UPnP service started anew are related. The service-start notifying unit 342 sends the generated related-service broadcast packet to the other information processing apparatuses.

For example, when the UPnP service 10b is started anew and the provided-service storage area 331 changes to a state illustrated in FIG. 16, the service-start notifying unit 342 acquires the relation ID “001” corresponding to the service ID “10b” from the provided-service storage area 331. The service-start notifying unit 342 acquires the service IDs “10a” and “10b” with the relation ID “001” and operation state “in operation”. Consequently, the service-start notifying unit 342 judges that the UPnP service 10a and the UPnP service 10b are related and generates a related-service broadcast packet indicating that the UPnP service 10a and the UPnP service 10b are related.

An existence-confirmation notifying unit 343 of the UPnP control unit 340 has the same function as that of the conventional information processing apparatus 900a. The existence-confirmation notifying unit 343 sends the other information processing apparatuses a broadcast packet for each of UPnP services before a validity period included in the last broadcast packet expires.

A broadcast receiving unit 344 of the UPnP control unit 340 updates, when receiving a related-service broadcast packet, the received-service storage area 332 to make relation IDs of UPnP services included in the related-service broadcast packet identical. For example, when information indicating that service IDs “30a” and “30b” are related is included in the related-service broadcast packet, the broadcast receiving unit 344 updates the received-service storage area 332 to make relation IDs of the UPnP services 30a and 30b identical as indicated by an example of the received-service storage area 332 illustrated in FIG. 17.

When a broadcast packet is received, the broadcast receiving unit 344 retrieves a UPnP service related to a UPnP service indicated by the broadcast packet from the received-service storage area 332. When the UPnP service related to the UPnP service indicated by the broadcast packet is present, the broadcast receiving unit 344 judges whether the received broadcast packet is not processed. For example, as described above, when a broadcast packet with a smaller service ID is discarded, a broadcast receiving unit 314 discards the received broadcast packet when a service ID of the UPnP service indicated by the received broadcast packet is smaller than a service ID of the UPnP service related to the UPnP service. When the received broadcast packet is not discarded, the broadcast receiving unit 344 updates validity periods in the received-service storage area 332 of the UPnP service indicated by the broadcast packet and the UPnP service related to the UPnP service to a validity period included in the broadcast packet.

FIG. 18 is a flowchart of broadcast packet transmission processing and related-service-broadcast-packet transmission processing performed by the service-start notifying unit 342.

As illustrated in FIG. 18, when a new UPnP service is started by the service providing unit 141 (Yes at Step S501), the service-start notifying unit 342 retrieves a UPnP service that is related to the UPnP service started anew and is in operation from the provided-service storage area 331 (Step S502).

When the UPnP service that is related to the UPnP service started anew and is in operation is retrieved (Yes at Step S503), the service-start notifying unit 342 generates a related-service broadcast packet indicating that the retrieved UPnP service and the UPnP service started anew are related, and sends the generated related service broadcast packet to the other information processing apparatuses (Step S504). The service-start notifying unit 342 sends the other information processing apparatuses a broadcast packet of the UPnP service started anew (Step S505).

On the other hand, when the UPnP service that is related to the UPnP service started anew and is in operation is not retrieved (No at Step S503), the service-start notifying unit 342 sends the other information processing apparatuses a broadcast packet of the UPnP service started anew (Step S505).

As explained above, in the information processing apparatus 300 according to the third embodiment, when a new UPnP service is started, the service-start notifying unit 342 sends other information processing apparatuses a broadcast packet of the UPnP service started anew. The service-start notifying unit 342 retrieves a UPnP service that is related to the UPnP service started anew and is in operation from the provided-service storage area 331. The service-start notifying unit 342 sends the other information processing apparatuses a related-service broadcast packet indicating that the retrieved UPnP service and the UPnP service started anew are related. Therefore, even when a complex UPnP service is provided, it is possible to set validity periods for sub-UPnP services included in the complex UPnP service to expire at the same time and to reduce the number of broadcast packets. Moreover, as existence confirmation notification after the start of a UPnP service, it is possible to use a broadcast packet according to the conventional standards.

The configuration of the information processing apparatus 100 explained in the first embodiment can be combined with others. For example, the configuration of the information processing apparatus 100 can be combined with the configuration disclosed in Japanese Patent Application No. 2007-013626 filed by the applicant. In a fourth embodiment, an example of a combination of the configuration of the information processing apparatus 100 explained in the first embodiment and the configuration disclosed in Japanese Patent Application No. 2007-013626 is explained.

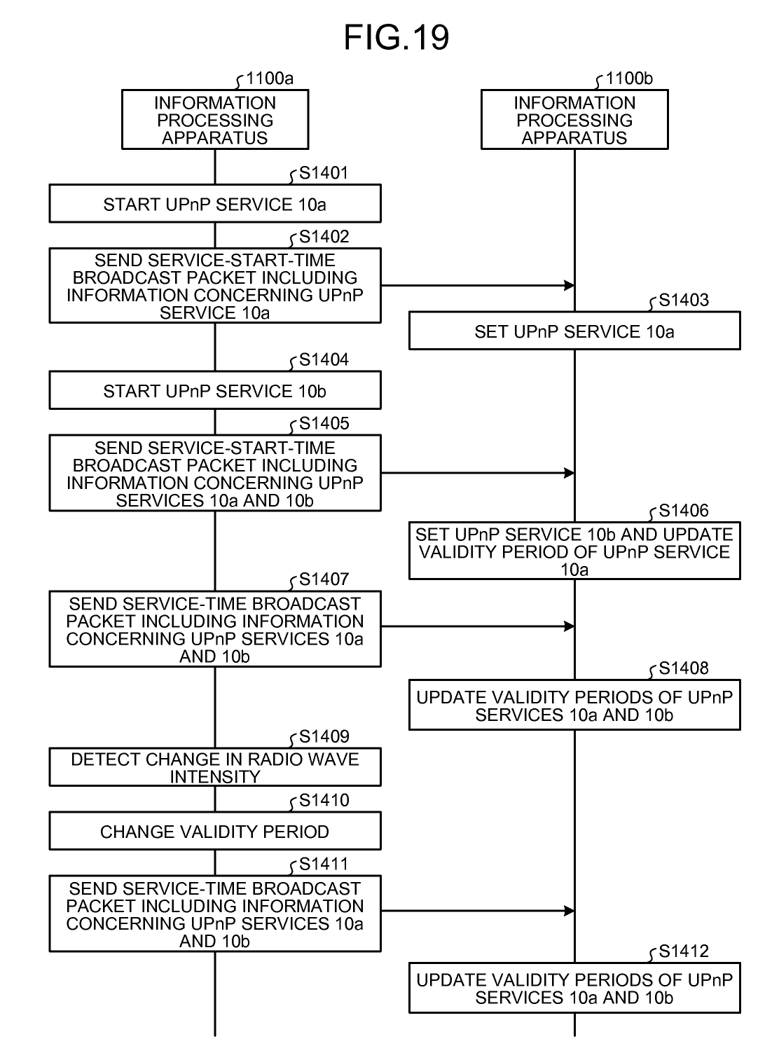

FIG. 19 is a sequence chart of a processing flow in a UPnP service provision system in a UPnP network including information processing apparatuses 1100a and 1100b according to the fourth embodiment. The information processing apparatuses 1100a and 1100b according to the fourth embodiment in FIG. 19 correspond to the information processing apparatuses la to Id of FIG. 1. The information processing apparatuses 1100a and 1100b are assumed to be mobile devices such as portable terminals. Explanation of a processing procedure (Steps S1401 to S1408), the same processing as previously described in connection with FIG. 3, is omitted.

As illustrated in FIG. 19, the information processing apparatus 1100a detects a change in radio wave intensity (Step S1409). The information processing apparatus 1100a changes a value of a validity period set in a service-time broadcast packet (Step S1410).

Specifically, the information processing apparatus 1100a judges that a communication state of the information processing apparatus 1100a is more stable as the radio wave intensity is higher and sets a validity period longer. This is because, when the radio wave intensity is high and the communication state is stable, it is unlikely that the information processing apparatus 1100a immediately leaves or is immediately disconnected from the network 2. Consequently, when the radio wave intensity is high, the validity period is long, and it is possible to reduce the number of service-time broadcast packets. As a result, it is possible to reduce network load.

The information processing apparatus 1100a judges that a communication state of the information processing apparatus 1100a is more unstable as radio wave intensity is lower and sets a validity period short. This is because, when the radio wave intensity is low and the communication state is unstable, it is likely that the information processing apparatus 1100a leaves or is disconnected from the network 2. Consequently, when the radio wave intensity is low, the validity period is short. Therefore, when the information processing apparatus 1100a leaves the network 2, the other information processing apparatus 1100b can quickly recognize that the information processing apparatus 1100a leaves the network 2.

The information processing apparatus 1100a sends the information processing apparatus 1100b a service-time broadcast packet including the validity period with the changed value (Step S1411). Upon receipt of the service-time broadcast packet, the information processing apparatus 1100b updates validity periods of the UPnP services 10a and 10b to the validity period included in the service-time broadcast packet (Step S1412).

As explained above, in addition to the configuration of the first embodiment, each of the information processing apparatuses 1100a and 1100b according to the fourth embodiment is configured to change, based on a change in a radio wave state, a value of a validity period set in a service-time broadcast packet. Therefore, even when a complex UPnP service is provided, it is possible to set validity periods for sub-UPnP services included in the complex UPnP service to expire at the same time and to reduce the number of broadcast packets. Moreover, when radio wave intensity is high, it is possible to reduce network load and, when radio wave intensity is low, other information processing apparatuses can quickly recognize that the information processing apparatus leaves the network 2.

In the fourth embodiment, the information processing apparatus 1100a changes a set value of a validity period based on a change in radio wave intensity. However, the information processing apparatus 1100a can change the set value of the validity period based on a change in an apparatus state such as a communication band, a residual band, a residual power supply capacity, moving speed, or load.

In the fourth embodiment, a set value of a validity period set in a service-time broadcast packet is changed. However, the information processing apparatus 1100a can change, based on radio wave intensity, a validity period set in a service-start-time broadcast packet as well.

As in the fourth embodiment, the configuration of the information processing apparatus 200 explained in the second embodiment can be combined with the configuration disclosed in Japanese Patent Application No. 2007-013626 filed by the applicant. In a fifth embodiment, an example of a combination of the configuration of the information processing apparatus 200 explained in the second embodiment and the configuration disclosed in Japanese Patent Application No. 2007-013626 is explained.

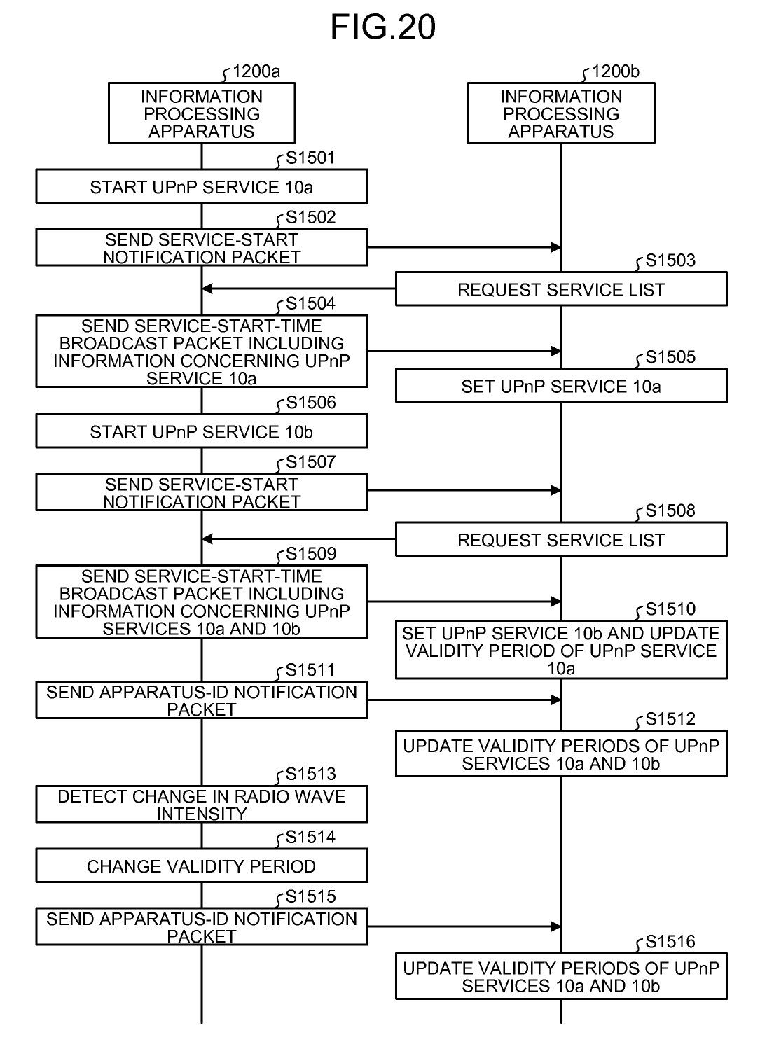

FIG. 20 is a sequence chart of a processing flow in a UPnP service provision system in a UPnP network including information processing apparatuses 1200a and 1200b according to the fifth embodiment. The information processing apparatuses 1200a and 1200b according to the fifth embodiment in FIG. 20 correspond to the information processing apparatuses 1a to 1d of FIG. 1. The information processing apparatuses 1200a and 1200b are assumed to be mobile devices such as portable terminals. Explanation of a processing procedure (Steps S1501 to S1512), the same processing as previously described in connection with FIG. 9, is omitted.

As illustrated in FIG. 20, the information processing apparatus 1200a detects a change in radio wave intensity (Step S1513). The information processing apparatus 1200a changes a value of a validity period set in an apparatus-ID notification packet (Step S1514). The information processing apparatus 1200a sends the information processing apparatus 1200b an apparatus-ID notification packet including the validity period with the changed value (Step S1515). When receiving the apparatus-ID notification packet, the information processing apparatus 1200b updates a validity period in the received-service storage area 232 corresponding to an apparatus ID included in the apparatus-ID notification packet to the validity period included in the apparatus-ID notification packet (Step S1516).

As explained above, in addition to the configuration of the second embodiment, each of the information processing apparatuses 1200a and 1200b according to the fifth embodiment is configured to change a value of a validity period set in an apparatus-ID notification packet. Therefore, even when a complex UPnP service is provided, it is possible to set validity periods for sub-UPnP services included in the complex UPnP service to expire at the same time and to reduce the number of broadcast packets. Moreover, when radio wave intensity is high, it is possible to reduce network load and, when radio wave intensity is low, other information processing apparatuses can quickly recognize that the information processing apparatus leaves the network 2.

As in the fourth and fifth embodiments, the configuration of the information processing apparatus 300 explained in the third embodiment can be combined with the configuration disclosed in Japanese Patent Application No. 2007-013626 filed by the applicant. In a sixth embodiment, an example of a combination of the configuration of the information processing apparatus 300 explained in the third embodiment and the configuration disclosed in Japanese Patent Application No. 2007-013626 is explained.

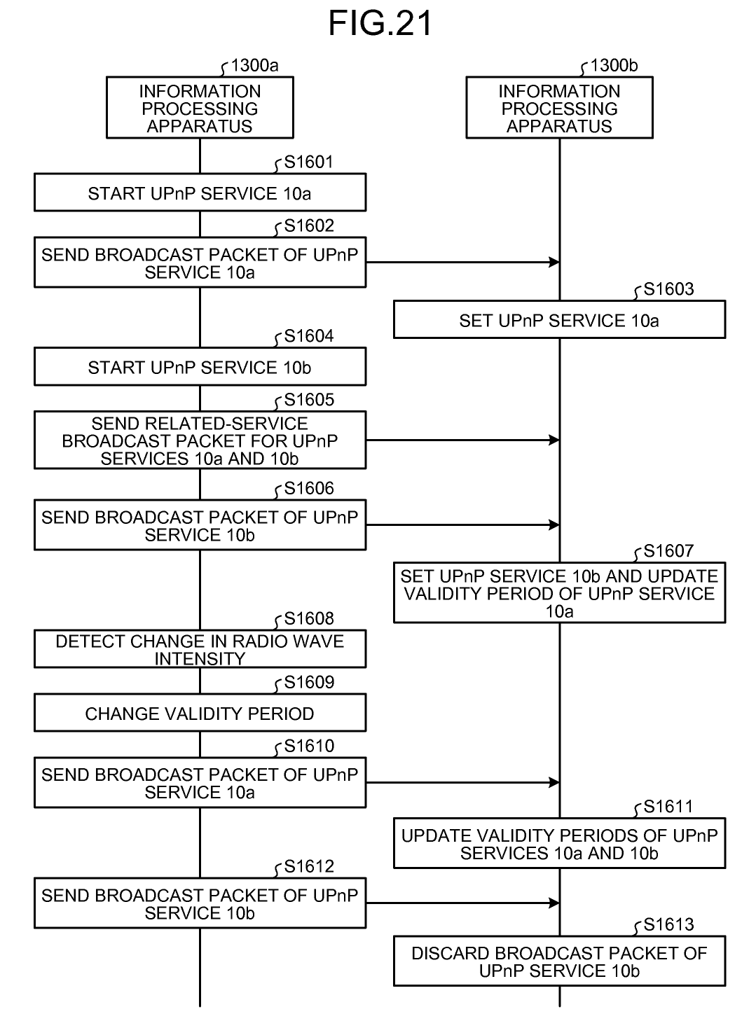

FIG. 21 is a sequence chart of a processing flow in a UPnP service provision system in a UPnP network including information processing apparatuses 1300a and 1300b according to the sixth embodiment. The information processing apparatuses 1300a and 1300b according to the sixth embodiment in FIG. 21 correspond to the information processing apparatuses 1a to 1d of FIG. 1. The information processing apparatuses 1300a and 1300b are assumed to be mobile terminals such as portable terminals. Explanation of a processing procedure (Steps S1601 to S1607), the same processing as previously described in connection with FIG. 14, is omitted.

As illustrated in FIG. 21, the information processing apparatus 1300a detects a change in radio wave intensity (Step S1608). The information processing apparatus 1300a changes a value of a validity period set in a broadcast packet (Step S1609). The information processing apparatus 1300a sends the information processing apparatus 1300b a broadcast packet of the UPnP service 10a including the validity period with the changed value (Step S1610). Upon receipt of the broadcast packet, the information processing apparatus 1300b updates validity periods of the UPnP service 10a and the UPnP service 10b related to the UPnP service 10a (Step S1611).

The information processing apparatus 1300a sends the information processing apparatus 1300b a broadcast packet of the UPnP service 10b including the validity period with the changed value (Step S1612). The information processing apparatus 1300b discards the broadcast packet (Step S1613).

As explained above, in addition to the configuration of the third embodiment, each of the information processing apparatuses 1300a and 1300b according to the sixth embodiment is configured to change a value of a validity period set in a broadcast packet based on a change in a radio wave state. Therefore, even when a complex UPnP service is provided, it is possible to set validity periods for sub-UPnP services included in the complex UPnP service to expire at the same time and to reduce the number of broadcast packets. Moreover, when radio wave intensity is high, it is possible to reduce network load and, when radio wave intensity is low, other information processing apparatuses can quickly recognize that the information processing apparatus leaves the network 2.

The configuration of the information processing apparatus 100 explained in the first embodiment can be combined with the configuration disclosed in Japanese Patent Application No. 2007-047339 filed by the applicant. In a seventh embodiment, an example of a combination of the configuration of the information processing apparatus 100 explained in the first embodiment and the configuration disclosed in Japanese Patent Application No. 2007-047339 is explained.

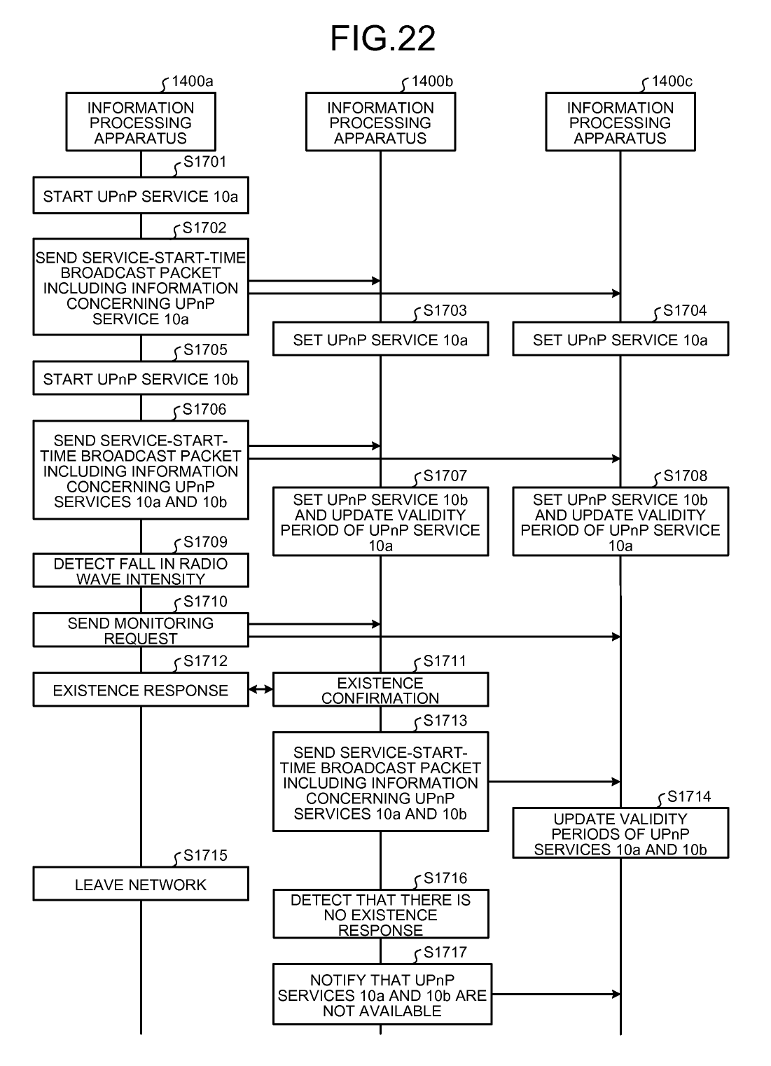

FIG. 22 is a sequence chart of a processing flow in a UPnP service provision system in a UPnP network including information processing apparatuses 1400a to 1400c according to the seventh embodiment. The information processing apparatuses 1400a to 1400c according to the seventh embodiment in FIG. 22 correspond to the information processing apparatuses la to Id of FIG. 1. The information processing apparatuses 1400a and 1400c are assumed to be mobile devices such as portable terminals and the information processing apparatus 1400b is assumed to be a non-mobile device such as a server. Explanation of a processing procedure (Steps S1701 to S1708), the same processing as previously described in connection with FIG. 3, is omitted.

As illustrated in FIG. 22, the information processing apparatus 1400a detects a fall in radio wave intensity (Step S1709) and judges whether monitoring is necessary. When the information processing apparatus 1400a is likely to leave the network 2 because a communication state is unstable, it sends the information processing apparatuses 1400b and 1400c a monitoring request (Step S1710). It is assumed that, because the information processing apparatus 1400b as a non-mobile device is more stable than the information processing apparatus 1400c as a mobile device, the information processing apparatus 1400b monitors the information processing apparatus 1400a.

The information processing apparatus 1400b sends existence confirmation notification for confirming at predetermined intervals that the information processing apparatus 1400a does not leave the network 2 to the information processing apparatus 1400a (Step S1711). When the information processing apparatus 1400a that receives the existence confirmation notification is connected to the network 2 and can perform communication, the information processing apparatus 1400a sends an existence response to the information processing apparatus 1400b (Step S1712).

The information processing apparatus 1400b sends a service-start-time broadcast packet to the information processing apparatus 1400c instead of the information processing apparatus 1400a (Step S1713). Upon receipt of the service-start-time broadcast packet, the information processing apparatus 1400c updates validity periods of the UPnP services 10a and 10b (Step S1714).

When the information processing apparatus 1400a leaves the network 2 (Step S1715), i.e., when the existence response is not received from the information processing apparatus 1400a, the information processing apparatus 1400b detects that the information processing apparatus 1400a leaves the network 2 (Step S1716). The information processing apparatus 1400b sends the information processing apparatus 1400c a message indicating that the UPnP services 10a and 10b are not available (Step S1717). In this message, information concerning a plurality of UPnP services can be set in a BYEBYE message in the UPnP.

As explained above, in addition to the configuration of the first embodiment, each of the information processing apparatuses 1400a to 1400c according to the seventh embodiment is configured to send, when it is judged based on a change in a radio wave state that a communication state is unstable, a monitoring request for the apparatus to the other information processing apparatuses. The other information processing apparatuses with stable communication state perform monitoring. Therefore, even when a complex UPnP service is provided, it is possible to set validity periods for sub-UPnP services included in the complex UPnP service to expire at the same time and to reduce the number of broadcast packets. Moreover, the other information processing apparatuses can quickly recognize that the information processing apparatus leaves the network 2.

As in the seventh embodiment, the configuration of the information processing apparatus 200 explained in the second embodiment can be combined with the configuration disclosed in Japanese Patent Application No. 2007-047339 filed by the applicant. In an eighth embodiment, an example of a combination of the configuration of the information processing apparatus 200 explained in the second embodiment and the configuration disclosed in Japanese Patent Application No. 2007-047339 is explained.

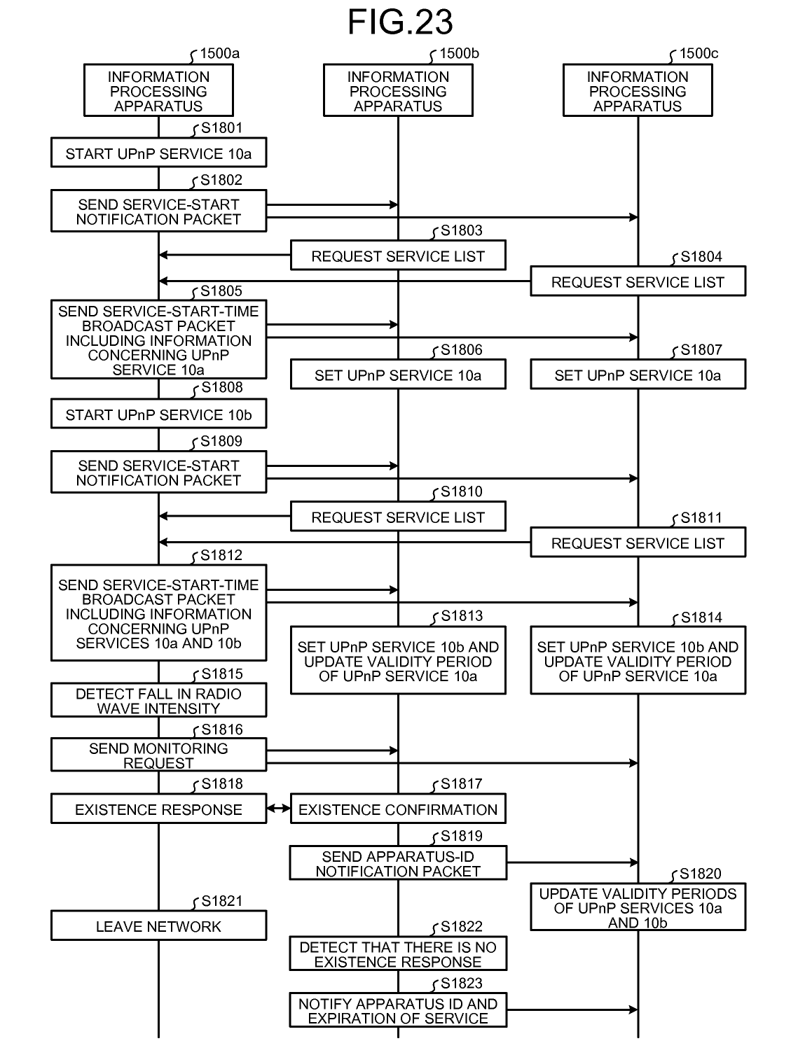

FIG. 23 is a sequence chart of a processing flow in a UPnP service provision system in a UPnP network including information processing apparatuses 1500a to 1500c according to the eighth embodiment. The information processing apparatuses 1500a to 1500c according to the eighth embodiment in FIG. 23 correspond to the information processing apparatuses 1a to 1d of FIG. 1. The information processing apparatuses 1500a and 1500c are assumed to be mobile devices such as portable terminals and the information processing apparatus 1500b is assumed to be a non-mobile device such as a server. Explanation of a processing procedure (Steps S1801 to S1820), the same processing as previously described in connection with FIGS. 9 and 22, is omitted.

As illustrated in FIG. 23, when the information processing apparatus 1500a leaves the network 2 (Step S1821), i.e., when the existence response is not sent from the information processing apparatus 1500a, the information processing apparatus 1500b detects that the information processing apparatus 1500a leaves the network 2 (Step S1822). The information processing apparatus 1500b sends the information processing apparatus 1500c an apparatus-ID notification packet including an apparatus ID of the information processing apparatus 1500a and a validity period “0” (Step S1823). Upon receipt of the apparatus-ID notification packet, the information processing apparatus 1500c recognizes that the UPnP services 10a and 10b provided by the information processing apparatus 1500a are not available.

As explained above, in addition to the configuration of the second embodiment, each of the information processing apparatuses 1500a to 1500c according to the eighth embodiment is configured to send, when it is judged based on a change in a radio wave state that a communication state is unstable, a monitoring request for the apparatus to the other information processing apparatuses. The other information processing apparatuses with stable communication state perform monitoring. Therefore, even when a complex UPnP service is provided, it is possible to set validity periods for sub-UPnP services included in the complex UPnP service to expire at the same time and to reduce the number of broadcast packets. Moreover, the other information processing apparatuses can quickly recognize that the information processing apparatus leaves the network 2.

As in the seventh and eighth embodiments, the configuration of the information processing apparatus 300 explained in the third embodiment can be combined with the configuration disclosed in Japanese Patent Application No. 2007-047339 filed by the applicant. In a ninth embodiment, an example of a combination of the configuration of the information processing apparatus 300 explained in the third embodiment and the configuration disclosed in Japanese Patent Application No. 2007-047339 is explained.

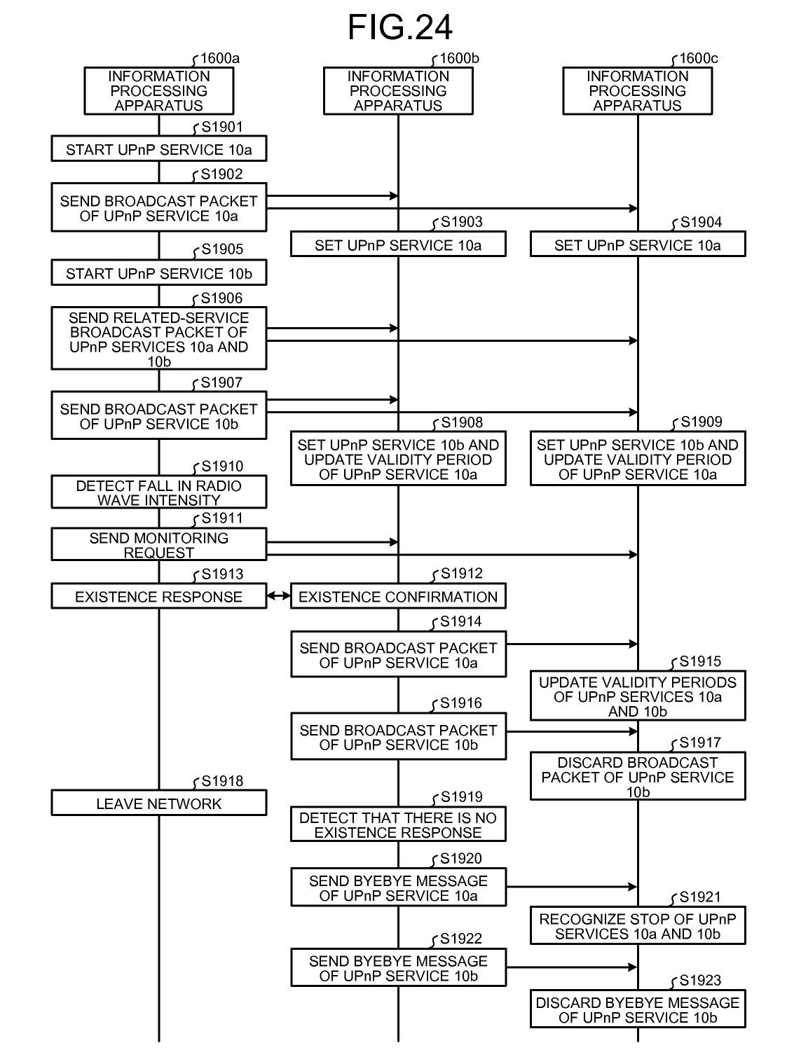

FIG. 24 is a sequence chart of a processing flow in a UPnP service provision system in a UPnP network including information processing apparatuses 1600a to 1600c according to the ninth embodiment. The information processing apparatuses 1600a to 1600c according to the ninth embodiment in FIG. 24 correspond to the information processing apparatuses 1a to 1d of FIG. 1. The information processing apparatuses 1600a and 1600c are assumed to be mobile devices such as portable terminals and the information processing apparatus 1600b is assumed to be a non-mobile device such as a server. Explanation of a processing procedure (Steps S1901 to S1917), the same processing as previously described in connection with FIGS. 14 and 22, is omitted.

As illustrated in FIG. 24, when the information processing apparatus 1600a leaves the network 2 (Step S1918), i.e., when the existence response is not sent from the information processing apparatus 1600a, the information processing apparatus 1600b detects that the information processing apparatus 1600a leaves the network 2 (Step S1919).

The information processing apparatus 1600b sends the information processing apparatus 1600c a BYEBYE message (stop notification) for the UPnP service 10a (Step S1920). Upon receipt of the BYEBYE message, the information processing apparatus 1600c recognizes that the UPnP service 10a is stopped and that the UPnP service 10b related to the UPnP service 10a is also stopped (Step S1921).

The information processing apparatus 1600b sends the information processing apparatus 1600c a BYEBYE message for the UPnP service 10b (Step S1922). The information processing apparatus 1600c discards the BYEBYE message (Step S1923).

As explained above, in addition to the configuration of the third embodiment, each of the information processing apparatuses 1600a to 1600c according to the ninth embodiment is configured to send, when it is judged based on a change in a radio wave state that a communication state is unstable, a monitoring request for the apparatus to the other information processing apparatuses. The other information processing apparatuses with stable communication state perform monitoring. Therefore, even when a complex UPnP service is provided, it is possible to set validity periods for sub-UPnP services included in the complex UPnP service to expire at the same time and to reduce the number of broadcast packets. Moreover, the other information processing apparatuses can quickly recognize that the information processing apparatus leaves the network 2.

The configuration of the information processing apparatus 100 explained in the first embodiment can be combined with the configuration disclosed in Japanese Patent Application No. 2007-047338 filed by the applicant. In a tenth embodiment, an example of a combination of the configuration of the information processing apparatus 100 explained in the first embodiment and the configuration disclosed in Japanese Patent Application No. 2007-047338 is explained.

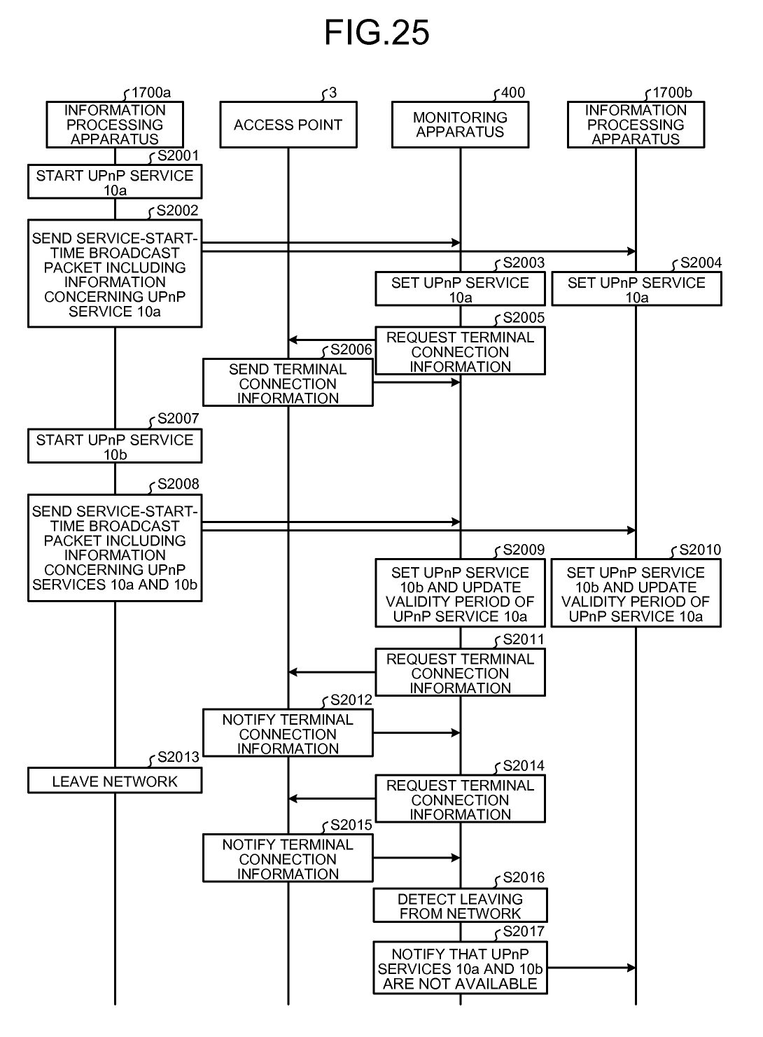

FIG. 25 is a sequence chart of a processing flow in a UPnP service provision system in a UPnP network including a monitoring apparatus 400 according to the tenth embodiment. An information processing apparatus 1700a in FIG. 25 corresponds to the information processing apparatus 1a of FIG. 1. An information processing apparatus 1700b in FIG. 25 corresponds to the information processing apparatus 1b in FIG. 1. The monitoring apparatus 400 corresponds to the information processing apparatus 1c in FIG. 1. The information processing apparatus 1700a is assumed to be a mobile device such as a portable terminal and connected to an access point 3. The monitoring apparatus 400 is assumed to be an information processing apparatus that monitors the information processing apparatus 1700a. The information processing apparatus 1700b is assumed to be a non-mobile device such as a personal computer.

As illustrated in FIG. 25, the information processing apparatus 1700a starts the UPnP service 10a (Step S2001). The information processing apparatus 1700a sends the monitoring apparatus 400 and the information processing apparatus 1700b a service-start-time broadcast packet of the UPnP service 10a (Step S2002). The monitoring apparatus 400 and the information processing apparatus 1700b perform predetermined setting work for using the UPnP service 10a (Steps S2003 and S2004).

The monitoring apparatus 400 sends the access point 3 an acquisition request for terminal connection information (Step S2005). In response to the acquisition request, the access point 3 sends the terminal connection information to the monitoring apparatus 400 (Step S2006).

In the terminal connection information stored by the access point 3, information concerning a radio apparatus connected to the access point 3 by radio is stored. The monitoring apparatus 400 can judge, based on the terminal connection information, whether the information processing apparatus 1700a leaves the network 2. The monitoring apparatus 400 periodically acquires the terminal connection information from the access point 3 and checks whether the information processing apparatus 1700a leaves the network 2. It is assumed that the monitoring apparatus 400 confirms that the information processing apparatus 1700a is connected to the network 2.

Subsequently, the information processing apparatus 1700a starts the UPnP service 10b (Step S2007). The information processing apparatus 1700a sends the monitoring apparatus 400 and the information processing apparatus 1700b service-start-time broadcast packets of the UPnP services 10a and 10b (Step S2008). The monitoring apparatus 400 and the information processing apparatus 1700b perform predetermined setting work for using the UPnP service 10b and updates a validity period of the UPnP service 10a (Steps S2009 and S2010).

The monitoring apparatus 400 sends a request for terminal connection information to the access point 3 (Step S2011). The access point 3 notifies the monitoring apparatus 400 of the terminal connection information (Step S2012).

The information processing apparatus 1700a leaves the network 2 (Step S2013). Thereafter, the monitoring apparatus 400 acquires the terminal connection information from the access point 3 (Steps S2014 and S2015) and checks whether the information processing apparatus 1700a leaves the network 2.

The monitoring apparatus 400 confirms that the information processing apparatus 1700a leaves the network 2 (Step S2016). The monitoring apparatus 400 sends the information processing apparatus 1700b a message indicating that the UPnP services 10a and 10b are not available (Step S2017). In the message, information concerning a plurality of UPnP services can be set in a BYEBYE message in the UPnP. Information concerning the UPnP services 10a and 10b is set in the message.

As explained above, in addition to the configuration of the first embodiment, the monitoring apparatus 400 according to the tenth embodiment is configured to monitor, based on the terminal connection information stored in the access point 3 connected via radio to the monitoring-object information processing apparatus 1700a, whether the information processing apparatus 1700a leaves the network 2. Therefore, even when a complex UPnP service is provided, it is possible to set validity periods for sub-UPnP services included in the complex UPnP service to expire at the same time and to reduce the number of broadcast packets. Moreover, other information processing apparatuses can quickly recognize that the information processing apparatus leaves the network 2.

As in the tenth embodiment, the configuration of the information processing apparatus 200 explained in the second embodiment can be combined with the configuration disclosed in Japanese Patent Application No. 2007-047338 filed by the applicant. In an eleventh embodiment, an example of a combination of the configuration of the information processing apparatus 200 explained in the second embodiment and the configuration disclosed in Japanese Patent Application No. 2007-047338 is explained.

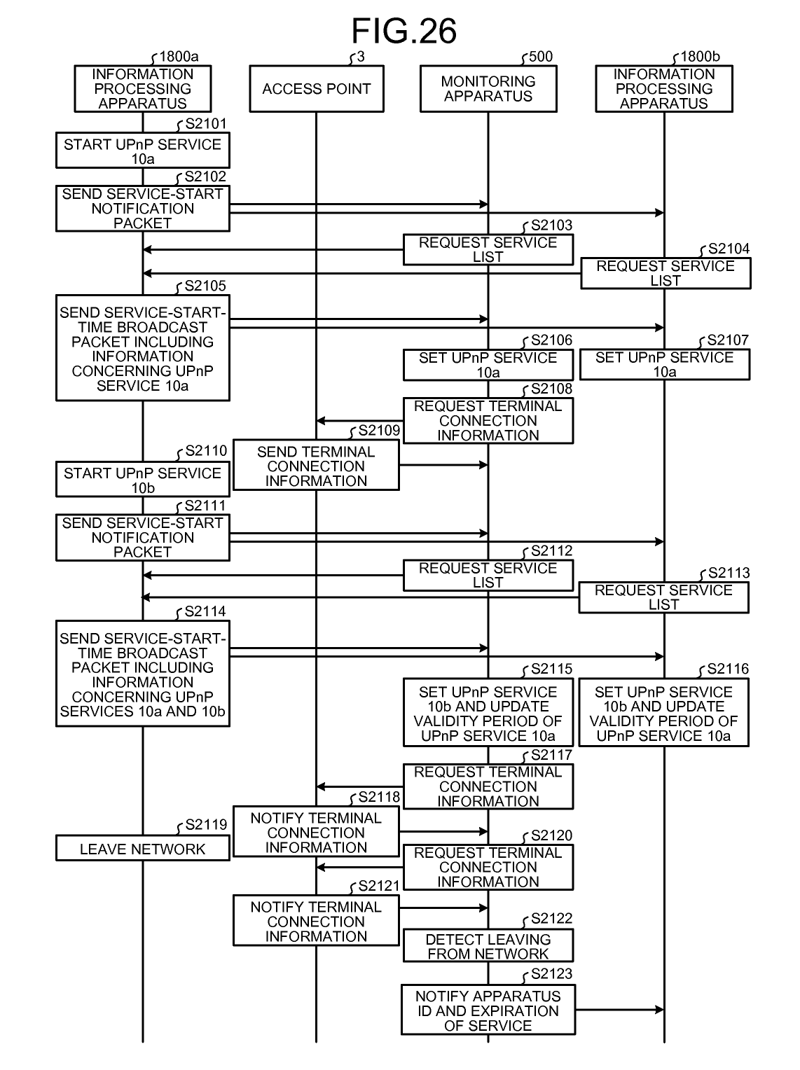

FIG. 26 is a sequence chart of a processing flow in a UPnP service provision system in a UPnP network including a monitoring apparatus 500 according to the eleventh embodiment. An information processing apparatus 1800a in FIG. 26 corresponds to the information processing apparatus 1a in FIG. 1. An information processing apparatus 1800b in FIG. 26 corresponds to the information processing apparatus 1b in FIG. 1. The monitoring apparatus 500 corresponds to the information processing apparatus 1c in FIG. 1. The information processing apparatus 1800a is assumed to be a mobile device such as a portable terminal and connected to the access point 3. The monitoring apparatus 500 is assumed to be an information processing apparatus that monitors the information processing apparatus 1800a. The information processing apparatus 1800b is assumed to be a non-mobile device such as a personal computer. Explanation of a processing procedure (Steps S2101 to S2118), the same processing as previously described in connection with FIGS. 9 and 25, is omitted.

As illustrated in FIG. 26, the information processing apparatus 1800a leaves the network 2 (Step S2119). The monitoring apparatus 500 acquires terminal connection information from the access point 3 (Steps S2120 and S2121) and checks whether the information processing apparatus 1800a leaves the network 2.

The monitoring apparatus 500 confirms that the information processing apparatus 1800a leaves the network 2 (Step S2122). The monitoring apparatus 500 sends the information processing apparatus 1800c an apparatus-ID notification packet including an apparatus ID and a validity period “0” of the information processing apparatus 1800a (Step S2123).

As explained above, in addition to the configuration of the second embodiment, the monitoring apparatus 500 according to the eleventh embodiment is configured to monitor, based on the terminal connection information stored in the access point 3 connected via radio to the monitoring-object information processing apparatus 1800a, whether the information processing apparatus 1800a leaves the network 2. Therefore, even when a complex UPnP service is provided, it is possible to set validity periods for sub-UPnP services included in the complex UPnP service to expire at the same time and to reduce the number of broadcast packets. Moreover, the other information processing apparatuses can quickly recognize that the information processing apparatus leaves the network 2.

As in the tenth and eleventh embodiments, the configuration of the information processing apparatus 300 explained in the third embodiment can be combined with the configuration disclosed in Japanese Patent Application No. 2007-047338 filed by the applicant. In a twelfth embodiment, an example of a combination of the configuration of the information processing apparatus 300 explained in the third embodiment and the configuration disclosed in Japanese Patent Application No. 2007-047338 is explained.

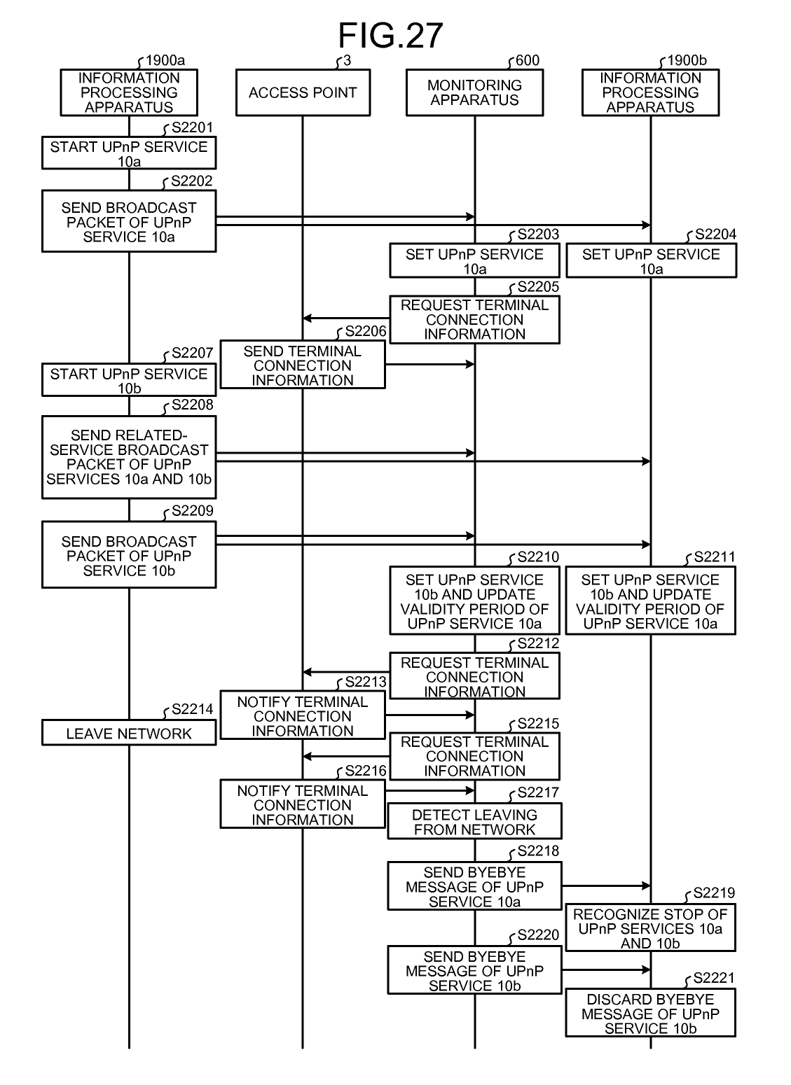

FIG. 27 is a sequence chart of a processing flow in a UPnP service provision system in a UPnP network including a monitoring apparatus 600 according to the twelfth embodiment. An information processing apparatus 1900a in FIG. 27 corresponds to the information processing apparatus 1a in FIG. 1. An information processing apparatus 1900b in FIG. 27 corresponds to the information processing apparatus 1b in FIG. 1. The monitoring apparatus 600 corresponds to the information processing apparatus 1c in FIG. 1. The information processing apparatus 1900a is assumed to be a mobile device such as a portable terminal and connected to the access point 3. The monitoring apparatus 600 is assumed to be an information processing apparatus that monitors the information processing apparatus 1900a. The information processing apparatus 1900b is assumed to be a non-mobile device such as a personal computer. Explanation of a processing procedure (Steps S2201 to S2213), the same processing as previously described in connection with FIGS. 14 and 25, is omitted.

The information processing apparatus 1900a leaves the network 2 (Step S2214). The monitoring apparatus 600 acquires terminal connection information from the access point 3 (Steps S2215 and S2216) and checks whether the information processing apparatus 1900a leaves the network 2.

The monitoring apparatus 600 confirms that the information processing apparatus 1900a leaves the network 2 (Step S2217). The monitoring apparatus 600 sends the information processing apparatus 1900b a BYEBYE message (stop notification) for the UPnP service 10a (Step S2218). Upon receipt of the BYEBYE message, the information processing apparatus 1900b recognizes that the UPnP service 10a is stopped and that the UPnP service 10b related to the UPnP service 10a is also stopped (Step S2219).

The monitoring apparatus 600 sends the information processing apparatus 1900b a BYEBYE message for the UPnP service 10b (Step S2220). The information processing apparatus 1900b discards the BYEBYE message (Step S2221).

As explained above, in addition to the configuration of the third embodiment, the monitoring apparatus 600 according to the twelfth embodiment is configured to monitor, based on the terminal connection information stored in the access point 3 connected via radio to the monitoring-object information processing apparatus 1900a, whether the information processing apparatus 1900a leaves the network 2. Therefore, even when a complex UPnP service is provided, it is possible to set validity periods for sub-UPnP services included in the complex UPnP service to expire at the same time and to reduce the number of broadcast packets. Moreover, other information processing apparatuses can quickly recognize that the information processing apparatus leaves the network 2. Furthermore, broadcast packet transmission processing for existence confirmation notification after the start of a UPnP service can be realized according to the conventional standards.

The information processing apparatus 100 according to the first embodiment illustrated in FIG. 4, the information processing apparatus 200 according to the second embodiment illustrated in FIG. 10, and the information processing apparatus 300 according to the third embodiment illustrated in FIG. 15 are explained above as hardware; however, they can be implemented as software. For example, a computer program (hereinafter, “information processing apparatus control program”) can be executed on a computer to implement the same function as the UPnP control unit 140 of the information processing apparatus 100 to thereby realize the same function as the information processing apparatus 100. Described below is an example of such a computer that executes an information processing apparatus control program 1071.

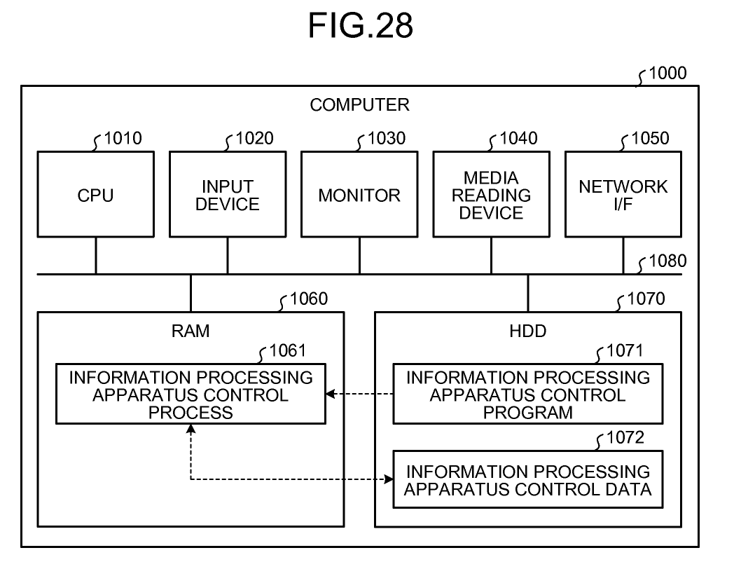

FIG. 28 is a block diagram of a computer 1000 that executes the information processing apparatus control program 1071. The computer 1000 is configured by connecting, via a bus 1080, a central processing unit (CPU) 1010 that executes various kinds of arithmetic processing, an input device 1020 that receives input of data from a user, a monitor 1030 that displays various kinds of information, a media reading device 1040 that reads a program and the like from a recording medium, a network I/F 1050 that performs exchange of data between the computer 1000 and other computers via a network, a random access memory (RAM) 1060 that temporarily stores various kinds of information, and a hard disk drive (HDD) 1070.

In the HDD 1070, the information processing apparatus control program 1071 having functions same as those of the UPnP control unit 140 and information processing apparatus control data 1072 corresponding to the various data stored in the storage unit 130 are stored. The information processing apparatus control data 1072 can be distributed as appropriate and stored in other computers connected to the computer 1000 via the network.

The CPU 1010 loads the information processing apparatus control program 1071 from the HDD 1070 into the RAM 1060 to perform an information processing apparatus control process 1061. In the information processing apparatus control process 1061, information and the like read from the information processing apparatus control data 1072 are loaded into an area allocated to the process on the RAM 1060 as appropriate and various kinds of data processing are performed based on the data and the like.

The information processing apparatus control program 1071 need not necessarily be stored in the HDD 1070. The computer 1000 can read and execute the program stored in a storage medium such as a compact disk-read only memory (CD-ROM). The program may be stored in another computer (or a server) or the like connected to the computer 1000 via a public line, the Internet, a local area network (LAN), a wide area network (WAN), or the like, and downloaded therefrom by the computer 1000 and executed.

When the elements of the information processing apparatus, the representations, or the arbitrary combinations of the elements disclosed herein are applied to methods, apparatuses, systems, computer programs, recording media, data structures, and the like, such methods, apparatuses, systems, computer programs, recording media, data structures, and the like are also effective as other forms of the present invention.

As set forth hereinabove, according to an embodiment of the present invention, even when the complex UPnP service is provided, it is possible to set validity periods for the sub-UPnP services included in the complex UPnP service to expire at the same time and to reduce the number of broadcast packets.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus that provides other information processing apparatus connected via a network with a plurality of services, the information processing apparatus comprising:
a storage unit that stores service identification numbers for identifying the services and operation state indicating whether the services are in operation;
a service-start notifying unit that retrieves, when a service starts anew, all services in operation from the storage unit, and notifies the other information processing apparatus of service start information including information indicating that the retrieved services are in operation and a validity period in which the other information processing apparatus recognizes that the services are in operation; and
a confirmation notifying unit that retrieves, before the validity period expires, all services in operation from the storage unit, and notifies the other information processing apparatus of service-time regular information including information indicating that the retrieved services are in operation and the validity period.

2. The information processing apparatus according to claim 1, wherein the service-start notifying unit notifies, when the service starts anew, the other information processing apparatus of service start notification including an identification number for identifying the information processing apparatus, and notifies, upon receipt of a request for the service start information in response to the service start notification, an information processing apparatus having sent the request of the service start information.

3. The information processing apparatus according to claim 2, wherein the confirmation notifying unit notifies the other information processing apparatus of the identification number and the validity period as the service-time regular information.

4. The information processing apparatus according to claim 1, wherein
the service-start notifying unit changes the validity period in the service start information based on communication state information indicating a state of the communication apparatus, and
the confirmation notifying unit changes the validity period in the service-time regular information based on the communication state information.

5. The information processing apparatus according to claim 4, wherein the communication state information includes at least one of radio wave intensity at which the communication apparatus transmits or receives data, bandwidth in which the communication apparatus transmits or receives data via the network, remaining power of a power supply for the communication apparatus, moving speed of the communication apparatus, load on the communication apparatus.

6. The information processing apparatus according to claim 4, wherein
the storage unit further stores a relation identification number indicating, for a complex service including a combination of a plurality of services, that the plurality of services are related to one another, and
the service-start notifying unit retrieves, when a new service starts, all services that are related to the new service and are in operation from the storage unit, and notifies the other information processing apparatus of related service information indicating that the retrieved services are related to one another.

7. An information processing apparatus that uses a plurality of services provided by a predetermined information processing apparatus as a service providing apparatus connected via a network, the information processing apparatus comprising:
a service-start notifying unit that, having received a request for monitoring the service providing apparatus from the service providing apparatus, detects that the service providing apparatus starts a new service, extracts all services in operation in the service providing apparatus, and notifies other information processing apparatus connected via the network than the service providing apparatus of service start information including information indicating that the extracted services are in operation and a validity period in which the other information processing apparatus recognizes that the services are in operation; and
a confirmation notifying unit that, having received a request for monitoring the service providing apparatus from the service providing apparatus, extracts all services in operation in the service providing apparatus before the validity period expires, and notifies the other information processing apparatus of service-time regular information including information indicating that the extracted services are in operation and the validity period.

8. The information processing apparatus according to claim 7, wherein the confirmation notifying unit notifies, upon detection of that the service providing apparatus is disconnected from the network, the other information processing apparatus that the service providing apparatus is disconnected from the network.

9. The information processing apparatus according to claim 8, wherein the confirmation notifying unit notifies the other information processing apparatus of the identification number and the validity period as the service-time regular information.

10. An information processing apparatus control method for controlling an information processing apparatus that provides other information processing apparatus connected via a network with a plurality of services, the information processing apparatus control method comprising:
storing, in the storage unit, service identification numbers for identifying the services and operation state indicating whether the services are in operation;
retrieving, when a service starts anew, all services in operation from the storage unit;
first notifying the other information processing apparatus of service start information including information indicating that the retrieved services are in operation and a validity period in which the other information processing apparatus recognizes that the services are in operation;
retrieving, before the validity period expires, all services in operation from the storage unit; and
second notifying the other information processing apparatus of service-time regular information including information indicating that the retrieved services are in operation and the validity period.

11. The information processing apparatus control method according to claim 10, wherein the first notifying includes
notifying, when the service starts anew, the other information processing apparatus of service start notification including an identification number for identifying the information processing apparatus, and
notifying, upon receipt of a request for the service start information in response to the service start notification, an information processing apparatus having sent the request of the service start information.

12. The information processing apparatus control method according to claim 11, wherein the second notifying includes notifying the other information processing apparatus of the identification number and the validity period as the service-time regular information.
